(19) United States
(12) Patent Application Publication
(10) Pub. No.: US 2015/0212683 A1
(43) Pub. Date: Jul. 30, 2015

(54) INFORMATION DISPLAY DEVICE AND DISPLAY INFORMATION OPERATION METHOD

(71) Applicant: MITSUBISHI ELECTRIC CORPORATION, Tokyo (JP)

(72) Inventors: Hidekazu Arita, Tokyo (JP); Mitsuo Shimotani, Tokyo (JP)

(73) Assignee: MITSUBISHI ELECTRIC CORPORATION, Tokyo (JP)

(21) Appl. No.: 14/425,715

(22) PCT Filed: Oct. 16, 2012
(86) PCT No.: PCT/JP2012/076679

§ 371 Date: Mar. 4, 2015

(51) Int. Cl. G06F 3/0485; G06F 3/0484; G06F 3/0488; G06F 3/0481

(52) U.S. Cl. CPC G06F 3/0485; G06F 3/04817; G06F 3/04845; G06F 3/04883

(57) ABSTRACT

An information display device includes: a processor configured to execute a program and a memory that stores the program which, when executed by the processor, results in performance of steps including, causing, when the user operation is a gesture operation associated with a screen image movement-or-modification type function of controlling display information on the display surface in a control direction set in accordance with a gesture direction, a continuation icon for executing the screen image movement-or-modification type function to be displayed on the display surface, and executing, when the user operation is an execution instruction operation with respect to the continuation icon, the screen image movement-or-modification type function in the control direction that is the same as that of the gesture operation involved in appearance of the continuation icon.

### TECHNICAL FIELD

The present invention relates to an information display device and a display information operation method.

### BACKGROUND ART

Patent Documents 1 and 2 listed below disclose devices making use of touch panels.

In a portable information device disclosed in Patent Document 1, by moving a finger on a screen on which a map image is displayed, the map image is moved in a direction of the finger movement by a distance of the finger movement. According to this, an instruction to perform scrolling and an amount of scrolling are input simultaneously by a history of the finger movement. Furthermore, by moving two fingers away from each other, an instruction to zoom in the map image and an amount of zoom-in are input by a history of the finger movement. Similarly, by moving two fingers toward each other, an instruction to zoom out the map image and an amount of zoom-out are input by a history of the finger movement. By rotating one finger about another finger, an instruction to rotate the map image and an amount of rotation are input by a history of the finger movement.

In a navigation device disclosed in Patent Document 2, a smooth scroll operation icon is displayed to perform continuous smooth scroll processing to a map image. Specifically, this icon is displayed in a lower right portion or in a lower left portion on the map image depending on a position of a driver's seat. By touching, with a finger, an arrow portion of the icon that indicates a predetermined direction, a navigation map image is moved in the direction indicated by the arrow portion at a high speed for the duration of the touch.

In addition, in the navigation device disclosed in Patent Document 2, touch scroll processing of moving a touch point to the center of a screen is performed by touching an area other than the above-mentioned smooth scroll operation icon. Furthermore, drag scroll processing of moving a map in accordance with a track of finger movement is performed by touching, with a finger, the area other than the above-mentioned smooth scroll operation icon, and then moving the finger on the screen.

As such, in the navigation device disclosed in Patent Document 2, an area for performing smooth scroll processing (i.e., the smooth scroll operation icon) and an area for performing touch scroll processing and drag scroll processing (i.e., the area other than the smooth scroll operation icon) are separated from each other. As a result, a user can issue an instruction to perform scroll processing of the user's intended type more precisely, compared to a case where a smooth scroll operation and a touch scroll operation are quite similar to each other (e.g. a case where the two operations differ from each other only in duration of touch on the screen).

### PRIOR ART DOCUMENT

### Patent Document

Patent Document 1: Japanese Patent Application Laid-Open No. 2000-163031

Patent Document 2: Japanese Patent Application Laid-Open No. 2010-32546

### SUMMARY OF INVENTION

### Problems to be Solved by the Invention

In the portable information device disclosed in Patent Document 1, the same finger movement has to be repeated a number of times to scroll a long distance, for example. The same applies to operations other than scrolling.

The navigation device disclosed in Patent Document 2 has been proposed to solve a problem of poor operability in the case where a smooth scroll operation and a touch scroll operation are quite similar to each other (e.g. the case where the two operations differ from each other only in duration of touch on the screen). A timing to perform a scroll operation is dependent upon a user's intension, and thus the smooth scroll operation icon has to be displayed at all times so that the smooth scroll operation icon can be used any time.

In addition, each arrow portion of the smooth scroll operation icon that indicates a direction of movement of the map has to be large enough to be touched with a finger. Providing arrow portions showing eight respective directions as disclosed in Patent Document 2 in the icon leads to an increase in size of the smooth scroll operation icon.

When a large icon is displayed at all times, visibility of a map is expected to be reduced. In such a case, use of the smooth scroll operation icon may even lead to reduction in convenience.

The present invention aims to provide a highly convenient information display device and a display information operation method.

### Means for Solving the Problems

An information display device according to one aspect of the present invention includes: a display unit having a display surface; an input unit receiving a user operation; and a controller. When the user operation is a gesture operation associated with a screen image movement-or-modification type function of controlling display information on the display surface in a control direction set in accordance with a gesture direction, the controller causes a continuation icon for executing the screen image movement-or-modification type function to be displayed on the display surface. When the user operation is an execution instruction operation with respect to the continuation icon, the controller executes the screen image movement-or-modification type function in the control direction that is the same as that of the gesture operation involved in appearance of the continuation icon.

### Effects of the Invention

According to the above-mentioned aspect, the continuation icon is called onto the display surface by the gesture operation, and, with use of the continuation icon, the screen image movement-or-modification type function associated with the above-mentioned gesture operation can be executed. Use of the continuation icon can thus reduce the number of times the gesture operation is repeated, leading to a reduction of an operational burden. As a result, a high convenience can be provided.

Furthermore, the continuation icon is displayed only by performing a gesture operation associated with a function desired to be executed. This means that the continuation icon is displayed automatically in accordance with a function intended by a user. As a result, a high convenience can be provided.

Moreover, the continuation icon is not called under a situation in which a user continues to view display information without performing any operation. The display information is thus not covered with the continuation icon.

The aim, features, and advantages of the present invention become more apparent from the following detailed description and the accompanying drawings.

### BRIEF DESCRIPTION OF DRAWINGS

FIG. 1 is a block diagram showing an example of an information display device.

FIG. 2 is a perspective view showing an example of an input and display unit.

FIG. 3 is a conceptual diagram of a single-point touch operation.

FIG. 4 is a conceptual diagram of a double-point touch operation.

FIG. 5 is a conceptual diagram of a drag operation.

FIG. 6 is a conceptual diagram of a flick operation.

FIG. 7 is a conceptual diagram of a pinch-out operation (double-point movement type).

FIG. 8 is a conceptual diagram of a pinch-out operation (single-point movement type).

FIG. 9 is a conceptual diagram of a pinch-in operation (double-point movement type).

FIG. 10 is a conceptual diagram of a pinch-in operation (single-point movement type).

FIG. 11 is a conceptual diagram of a slide operation.

FIG. 12 is a conceptual diagram of a display size change operation (a zoom-in operation and a zoom-out operation).

FIG. 13 is a conceptual diagram of a rotation operation.

FIG. 14 is a conceptual diagram of a slide continuation icon.

FIG. 15 illustrates a zoom-in continuation icon.

FIG. 16 illustrates a zoom-out continuation icon.

FIG. 17 illustrates a clockwise-rotation continuation icon.

FIG. 18 illustrates a counterclockwise-rotation continuation icon.

FIG. 19 is a block diagram showing an example of a controller.

FIG. 20 is a flow chart showing an example of processing to display a continuation icon.

FIG. 21 is a conceptual diagram of an end point condition.

FIG. 22 is a conceptual diagram of a continuation icon call operation.

FIG. 23 shows Example 1 of a display position of a continuation icon.

FIG. 24 shows Example 2 of the display position of the continuation icon.

FIG. 25 shows Example 3 of the display position of the continuation icon.

FIG. 26 shows Example 4 of the display position of the continuation icon.

FIG. 27 shows Example 1 of a method for obtaining an extended line from a gesture track.

FIG. 28 shows Example 2 of the method for obtaining the extended line from the gesture track.

FIG. 29 shows Example 3 of the method for obtaining the extended line from the gesture track.

FIG. 30 shows Example 5 of the display position of the continuation icon.

FIG. 31 illustrates a strip-shaped continuation icon.

FIG. 32 is a flow chart showing an example of processing performed after display of a continuation icon.

FIG. 33 shows Example 1 of a method for setting a slide direction.

FIG. 34 shows Example 2 of the method for setting the slide direction.

FIG. 35 is a conceptual diagram showing a relation between a gesture amount or a gesture speed and a control amount or a control speed for display information.

FIG. 36 shows an example of the control amount for the display information.

FIG. 37 shows an example of the control speed for the display information.

FIG. 38 is a flow chart showing an example of processing concerning deletion of a continuation icon.

FIG. 39 shows Example 1 of an operation to perform a slide and a display size change simultaneously.

FIG. 40 shows Example 2 of the operation to perform the slide and the display size change simultaneously.

FIG. 41 illustrates a cancellation operation.

FIG. 42 is a conceptual diagram showing an element connection display style.

### DESCRIPTION OF EMBODIMENT

<Overview of Overall Configuration>

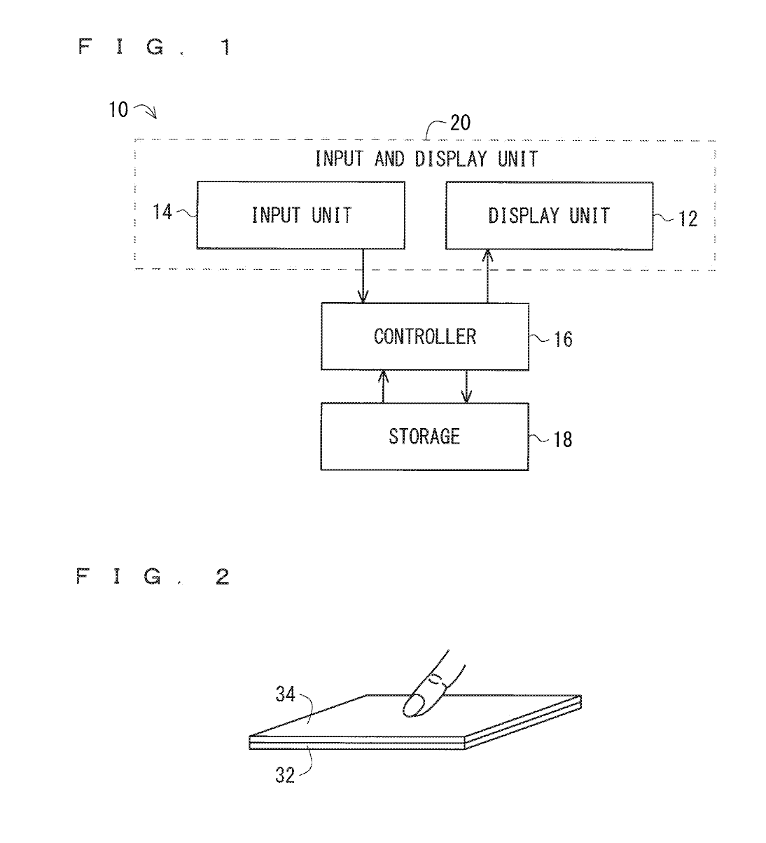

FIG. 1 is a block diagram showing an example of an information display device 10 according to an embodiment. According to the example of FIG. 1, the information display device 10 includes a display unit 12, an input unit 14, a controller 16, and a storage 18.

The display unit 12 displays a variety of information. The display unit 12 includes a display surface which is composed of a plurality of pixels that are arranged in a matrix, and a drive unit which drives each of the pixels based on image data acquired from the controller 16 (i.e., controls a display state of each of the pixels), for example. The display unit 12 may display any of a still image, a moving image, and a combination of a still image and a moving image.

The display unit 12 is configurable by a liquid crystal display device, for example. According to this example, a display area of a display panel (herein, a liquid crystal panel) corresponds to the above-mentioned display surface, and a drive circuit externally attached to the display panel corresponds to the above-mentioned drive unit.

The drive circuit may partially be incorporated in the display panel. In place of the liquid crystal display device, the display unit 12 is configurable by an electroluminescence (EL) display device, plasma display device, and the like.

The input unit 14 receives a variety of information from a user. The input unit 14 includes a detector which detects an indicator that the user uses for input, and a detected signal output unit which outputs a result of the detection performed by the detector to the controller 16 as a detected signal, for example.

An example in which the input unit 14 is configured by a so-called contact type touch panel is described herein, and thus the input unit 14 is hereinafter also referred to as a “touch panel 14”. The touch panel is also referred to as a “touchpad” and the like. An example in which the above-mentioned indicator used for input is a finger (more specifically, a fingertip) of the user is described below.

The above-mentioned detector of the touch panel 14 provides an input surface on which the user places the fingertip, and detects the finger placed on the input surface by using a sensor group provided for the input surface. In other words, an area in which the sensor group can detect the finger corresponds to an input area in which user input can be received, and, in the case of a contact type touch panel, the input area corresponds to an input surface in a two-dimensional area.

The sensor group may be composed of any of electric sensors, optical sensors, mechanical sensors, and the like, and may be composed of a combination of any of these sensors. Various position detection methods have been developed, and any of these methods may be used for the touch panel 14. A configuration that allows for detection of pressure applied by the finger to the input surface in addition to detection of the position of the finger may be used.

The position of the fingertip on the input surface can be specified by a combination of signals output from respective sensors. The specified position is represented by coordinate data on coordinates set to the input surface, for example. In this case, coordinate data that represents the position of the finger changes upon moving the finger on the input surface, and thus movement of the finger can be detected by a set of coordinate data acquired continuously.

The position of the finger may be represented by a system other than the coordinate system. That is to say, coordinate data is just an example of finger position data for representing the position of the finger.

An example in which the above-mentioned detected signal output unit of the touch panel 14 generates coordinate data that represents the position of the finger from the signals output from the respective sensors, and transmits the coordinate data to the controller 16 as the detected signal is described herein. However, conversion into the coordinate data may be performed by the controller 16, for example. In such an example, the detected signal output unit converts the signals output from the respective sensors into signals that the controller 16 can acquire, and transmits the resulting signals to the controller 16 as the detected signals.

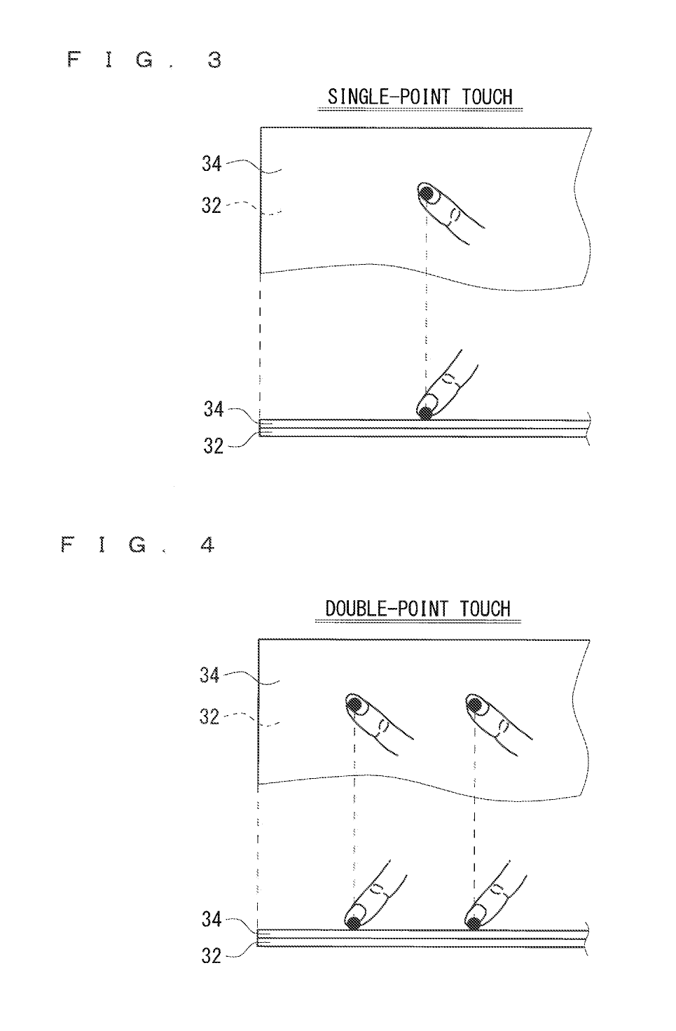

As illustrated in a perspective view of FIG. 2, an example in which an input surface 34 of the touch panel 14 (see FIG. 1) and a display surface 32 of the display unit 12 (see FIG. 1) are stacked, i.e., an example in which the input surface 34 and the display surface 32 are integrated with each other, is described herein. Such integration provides an input and display unit 20 (see FIG. 1), more specifically, a touchscreen 20.

By integrating the input surface 34 and the display surface 32 with each other, a user identifies the input surface 34 with the display surface 32, and feels as if the user performs an input operation with respect to the display surface 32. As a result, an intuitive operating environment is provided. In view of the above, for example, an expression “a user operates the display surface 32” is hereinafter also used.

The controller 16 performs various operations and controls in the information display device 10. For example, the controller 16 analyzes information input from the touch panel 14, generates image data in accordance with a result of the analysis, and outputs the image data to the display unit 12.

An example in which the controller 16 is configured by a central processing unit (e.g., configured by one or more microprocessors) and a main storage (e.g., configured by one or more storage devices, such as ROM, RAM, and flash memory) is described herein. According to this example, various functions are achieved by the central processing unit executing various programs stored in the main storage (i.e., by software). Various functions may be achieved in parallel.

Various programs may be stored in advance in the main storage of the controller 16, or may be read from the storage 18 and stored in the main storage at the time of execution. The main storage is used to store a variety of data in addition to programs. The main storage provides a work area used when the central processing unit executes a program. The main storage also provides an image holding unit into which an image to be displayed by the display unit 12 is written. The image holding unit is also referred to as “video memory”, “graphics memory”, and the like.

All or part of the operations and controls performed by the controller 16 may be configured as hardware (e.g., an arithmetic circuit configured to perform a specific operation).

The storage 18 stores therein a variety of information. The storage 18 is herein provided as an auxiliary storage used by the controller 16. The storage 18 is configurable by using at least one of storage devices including a hard disk device, an optical disc, rewritable non-volatile semiconductor memory, for example.

<User Operations and Associated Functions>

Prior to description of a more specific configuration and processing of the information display device 10, a user operation performed with respect to the touch panel 14 is described below.

The user operation is roughly classified into a touch operation and a gesture operation by movement of a finger. The touch operation and the gesture operation are hereinafter also referred to as a “touch” and a “gesture”, respectively. The touch operation refers to an operation of touching the input surface of the touch panel with at least one fingertip, and releasing the finger from the input surface without moving the finger on the input surface. On the other hand, the gesture operation refers to an operation of touching the input surface with at least one fingertip, moving (i.e., sliding) the finger on the input surface, and then releasing the finger from the input surface.

Coordinate data (i.e., the finger position data) detected through the tough operation basically remains unchanged, and is thus static. By contrast, coordinate data detected through the gesture operation changes over time, and is thus dynamic. With use of a set of coordinate data that changes over time as described above, information on a start point and an end point of movement of a finger on the input surface, a track from the start point to the end point of the movement, a direction of the movement, an amount of the movement, a speed of the movement, an acceleration of the movement, and the like can be acquired.

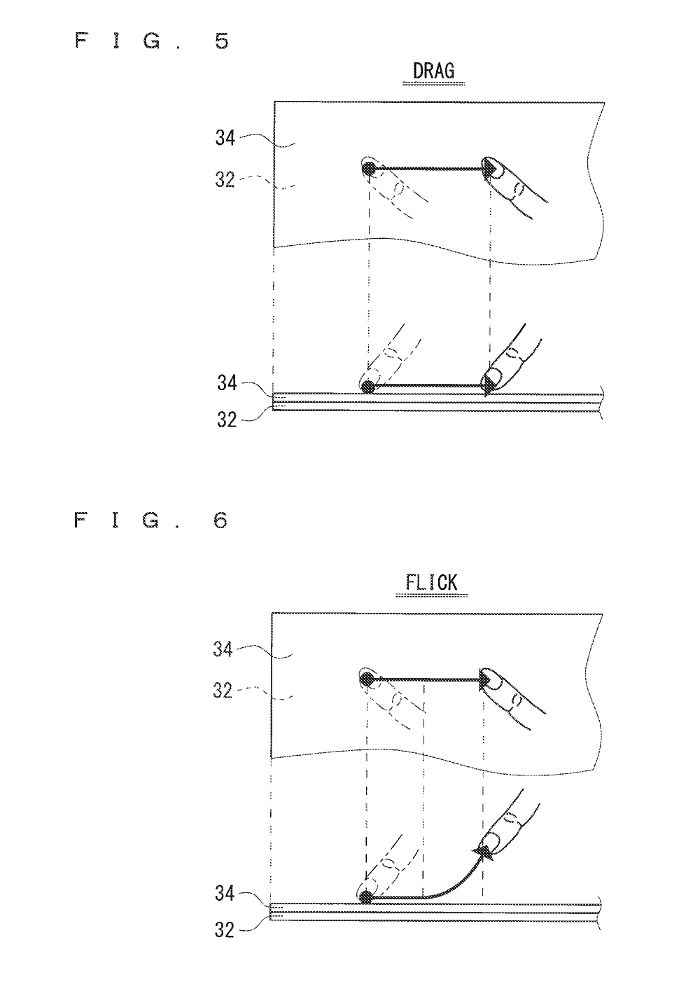

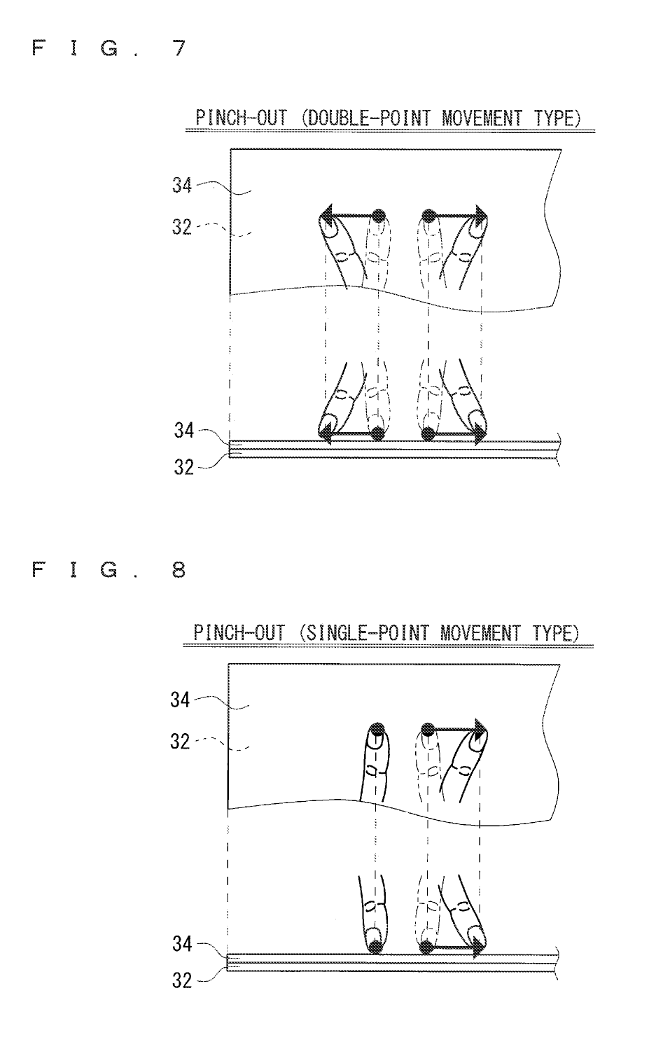

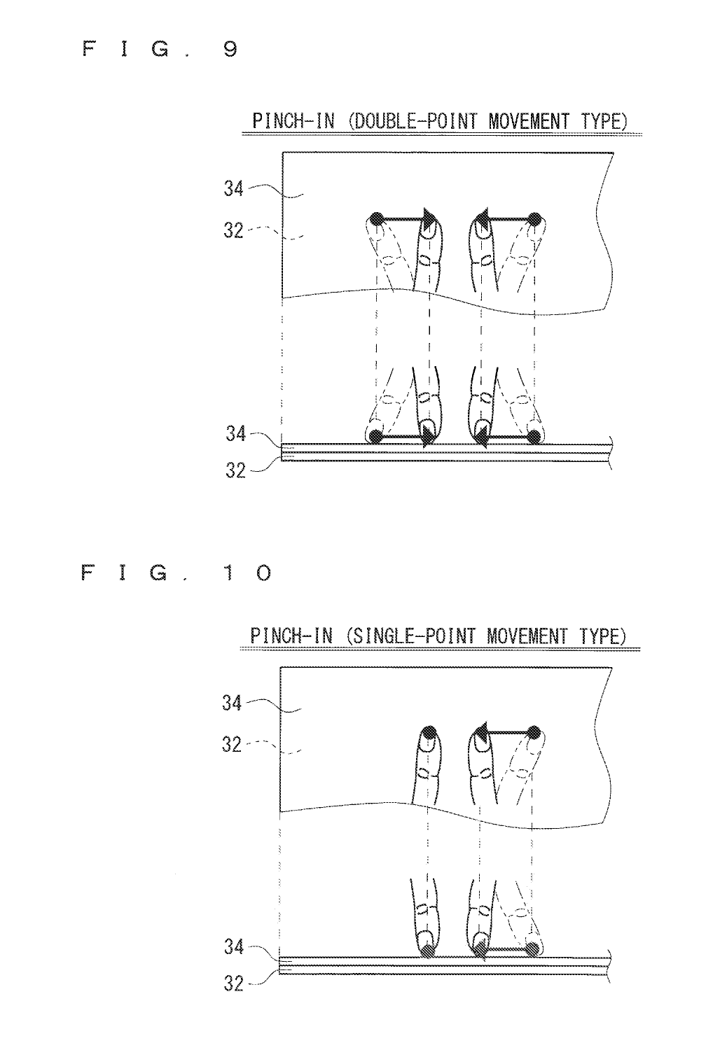

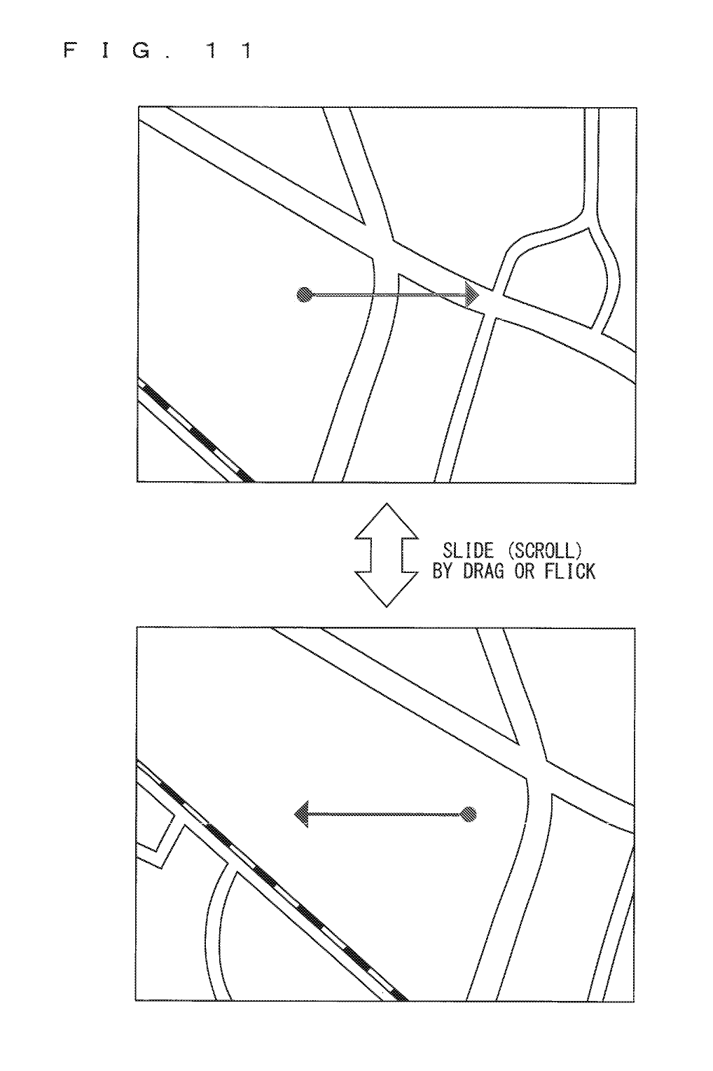

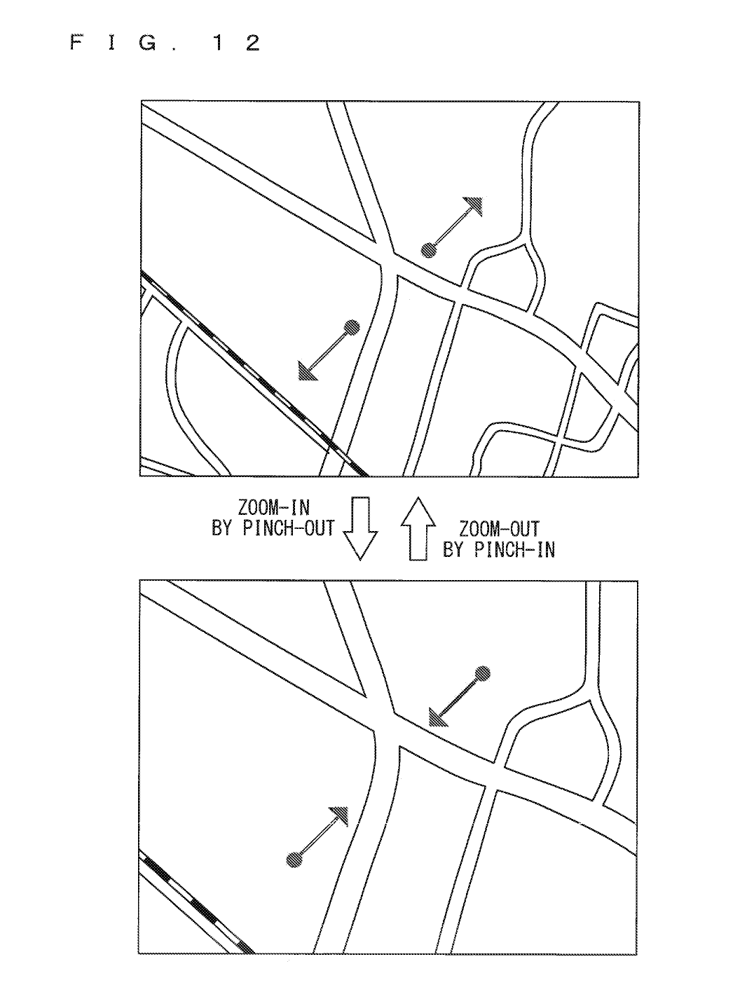

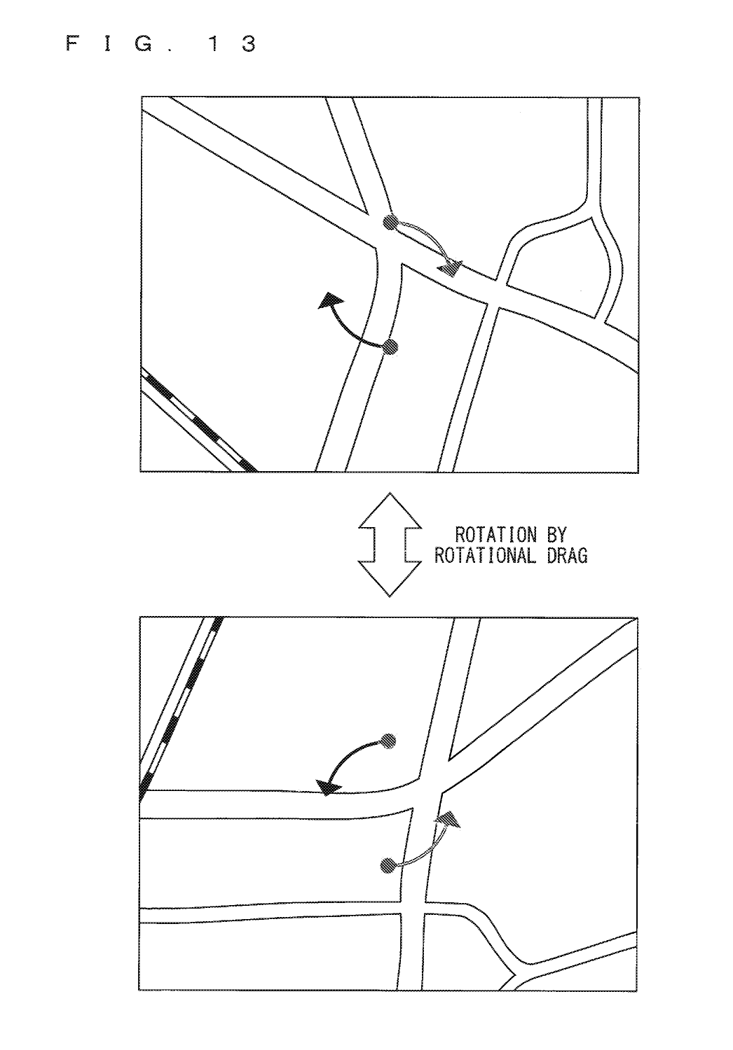

FIG. 3 is a conceptual diagram of a single-point touch operation (also simply referred to as a “single-point touch”) as Example 1 of the touch operation. An upper part and a lower part of each of FIG. 3 and FIGS. 4-10, which are described later, illustrate a plan view of the input surface 34, and a side view or a cross-sectional view of the input surface 34, respectively.

As illustrated in FIG. 3, in the single-point touch, a user brings one finger into point contact with the input surface 34. In FIG. 3, a touch point (i.e., a point at which the finger is detected) is schematically shown by a black circle. The same illustration method is applied to the drawings described later. The black circle may actually be displayed on the display surface.

The single-point touch can be classified into operations including a single tap, a multiple tap, and a long press. The single tap refers to an operation of tapping the input surface 34 once with a fingertip. The single tap is also simply referred to as a “tap”. The multiple tap refers to an operation of repeating a tap a plurality of times. A typical example of the multiple tap is a double tap. The long press is an operation of holding point contact with a fingertip. These operations are distinguishable from each other by the duration and the number of times of the contact with the finger (i.e., detection of the finger).

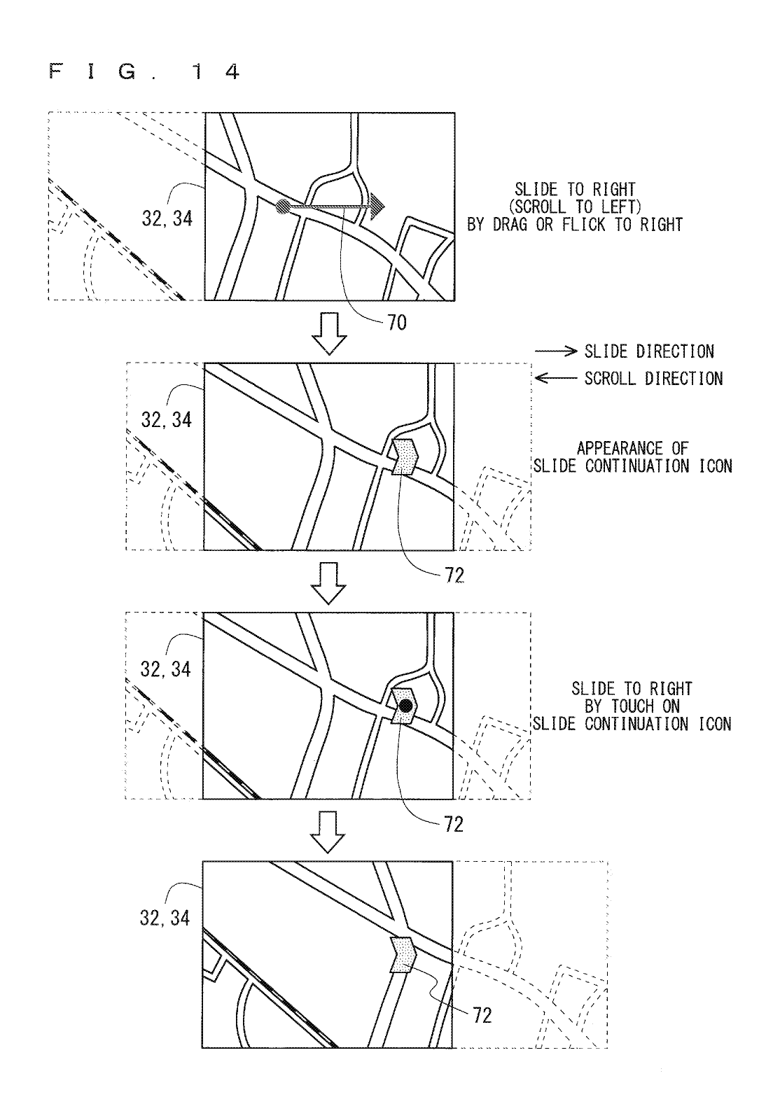

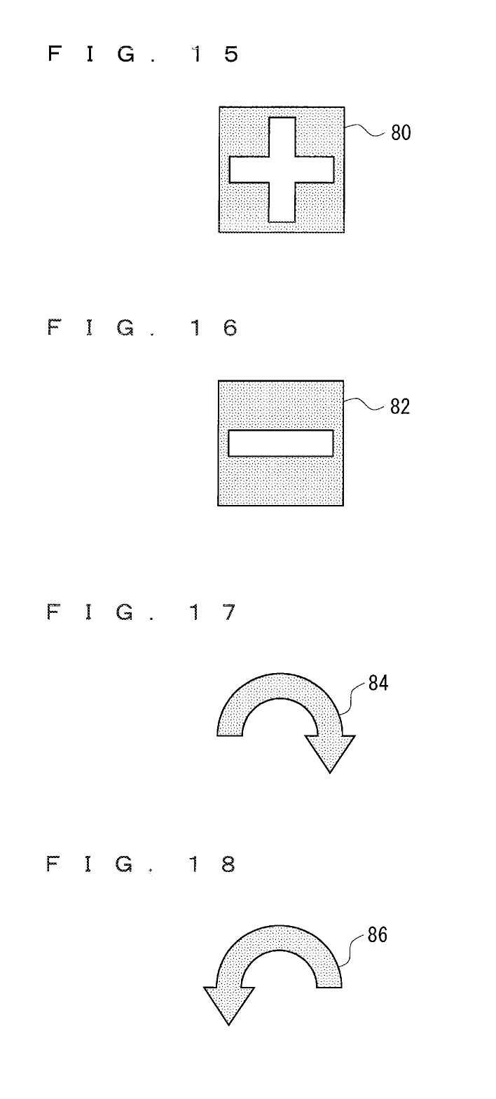

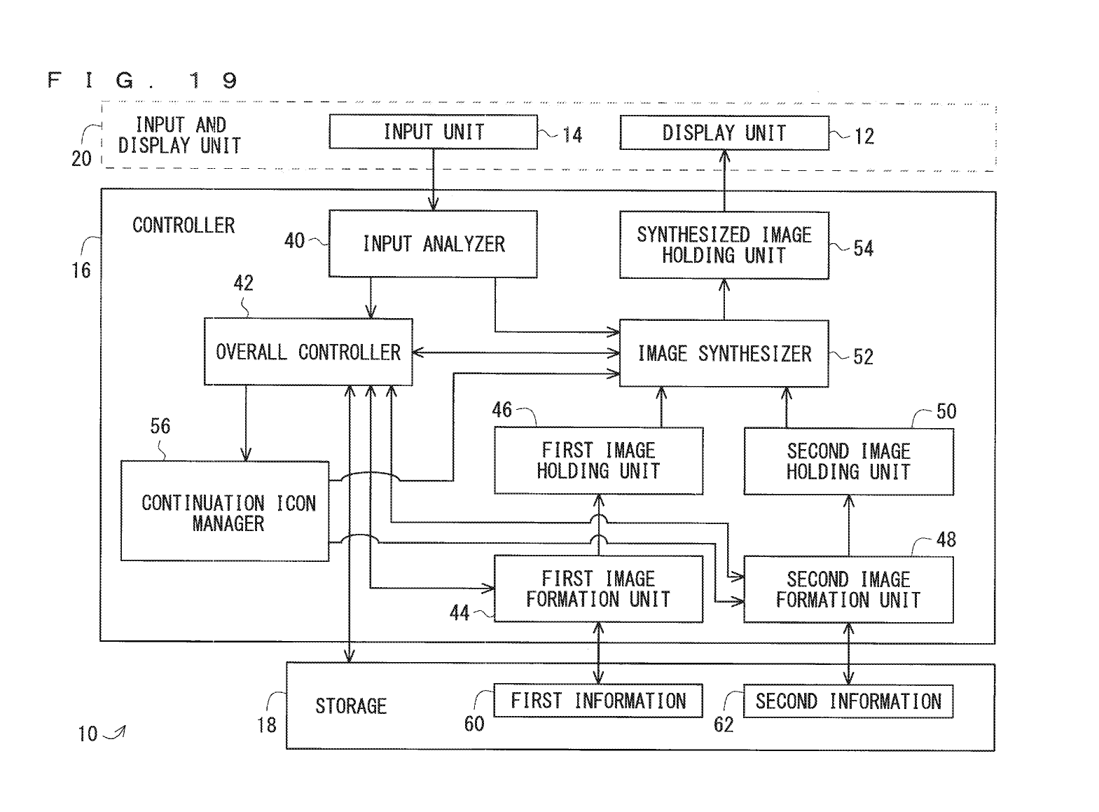

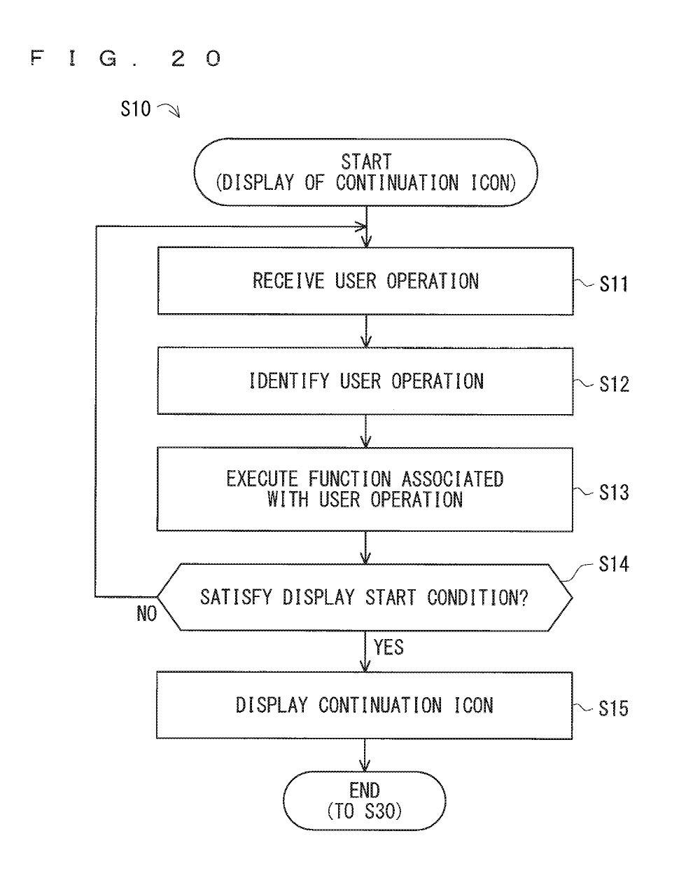

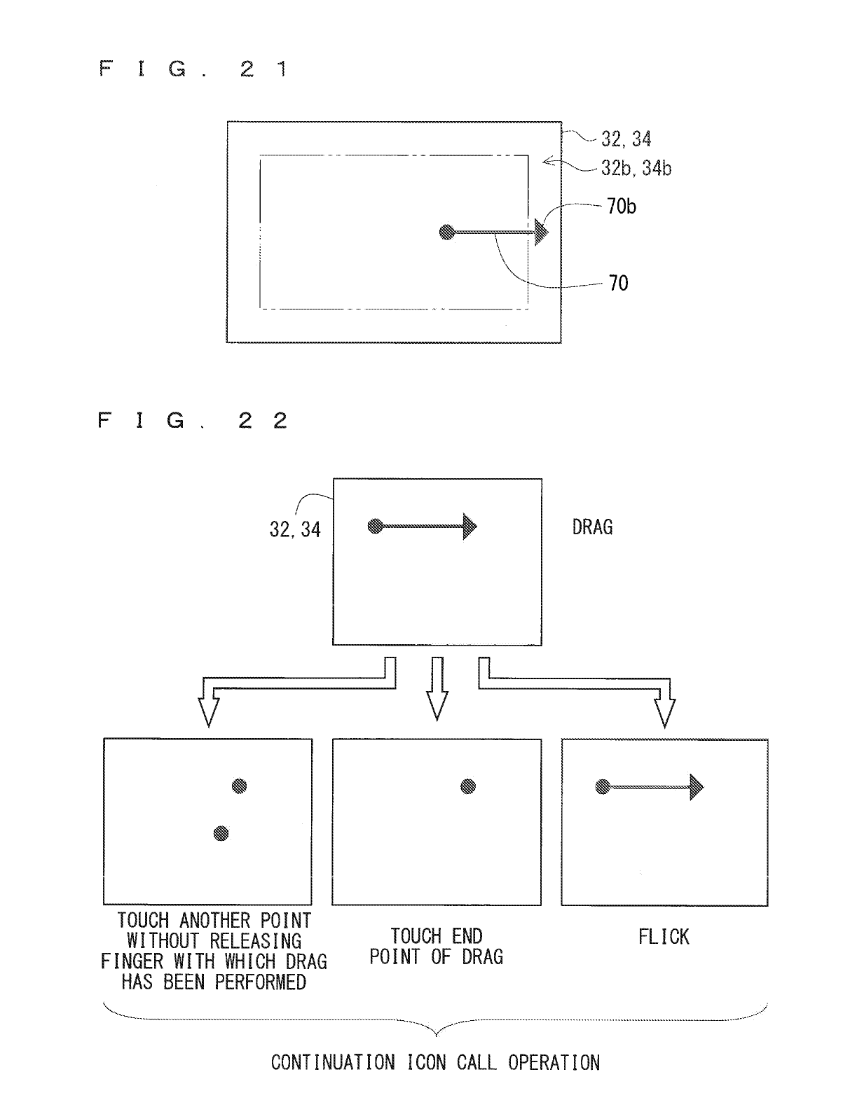

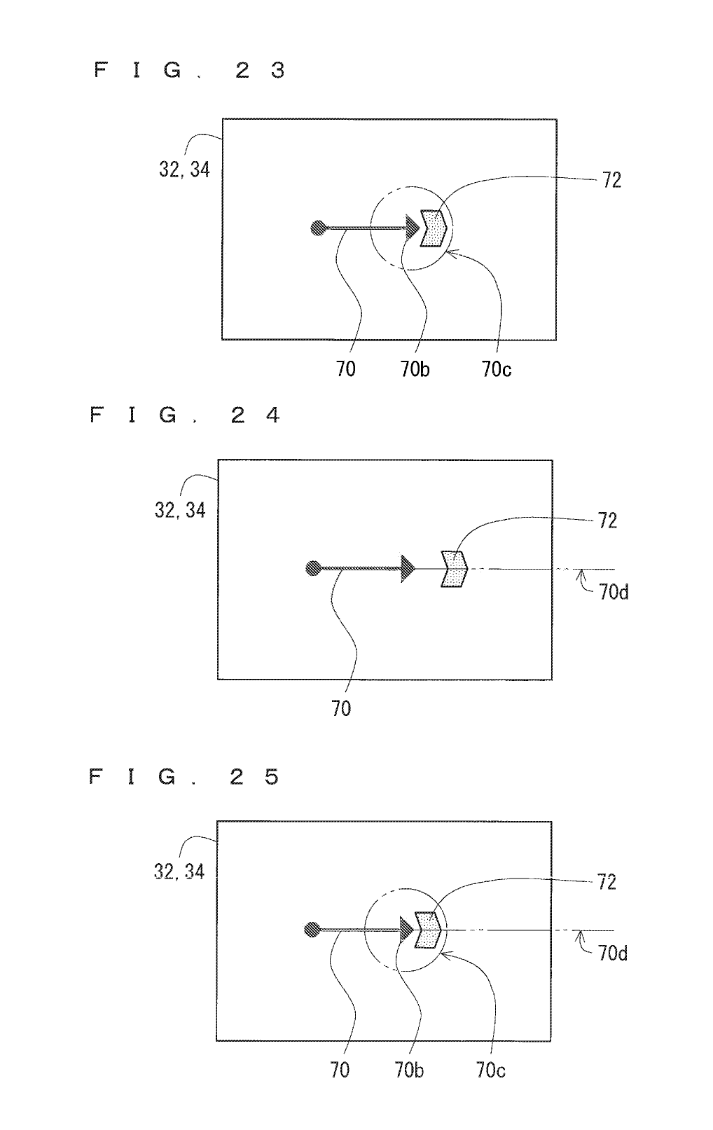

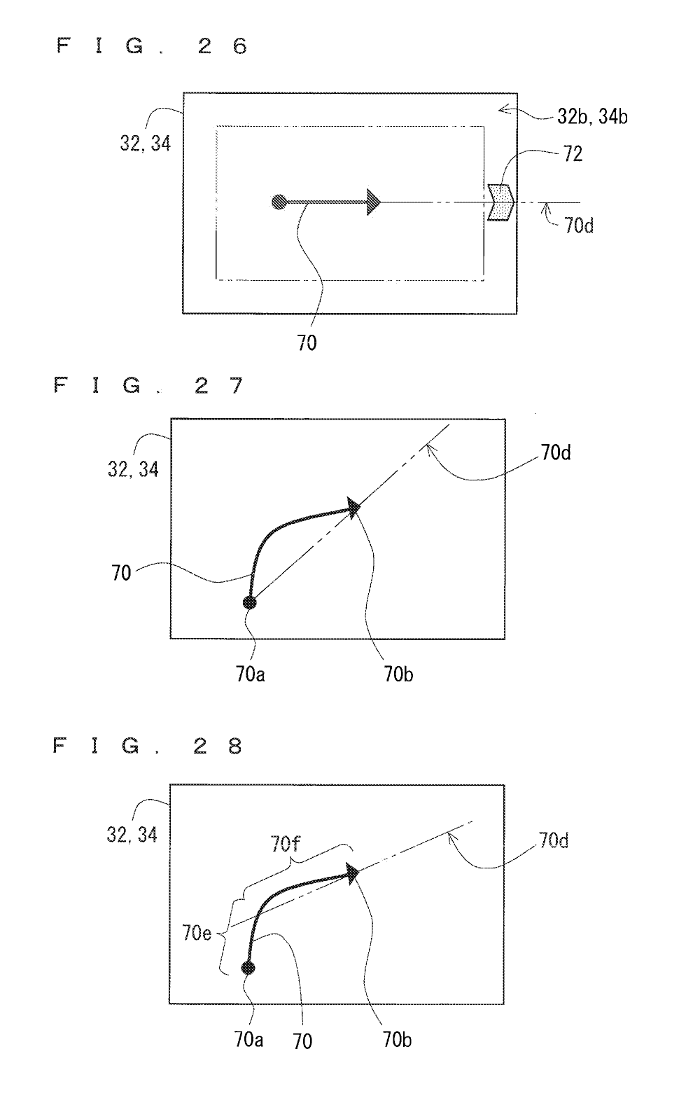

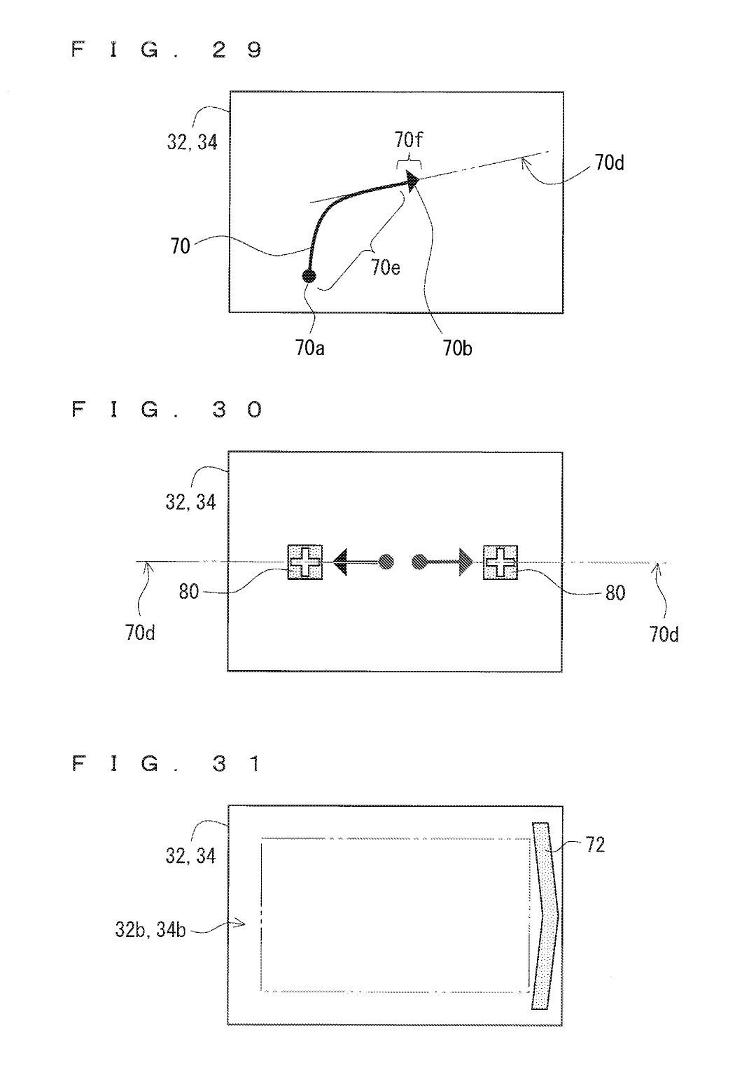

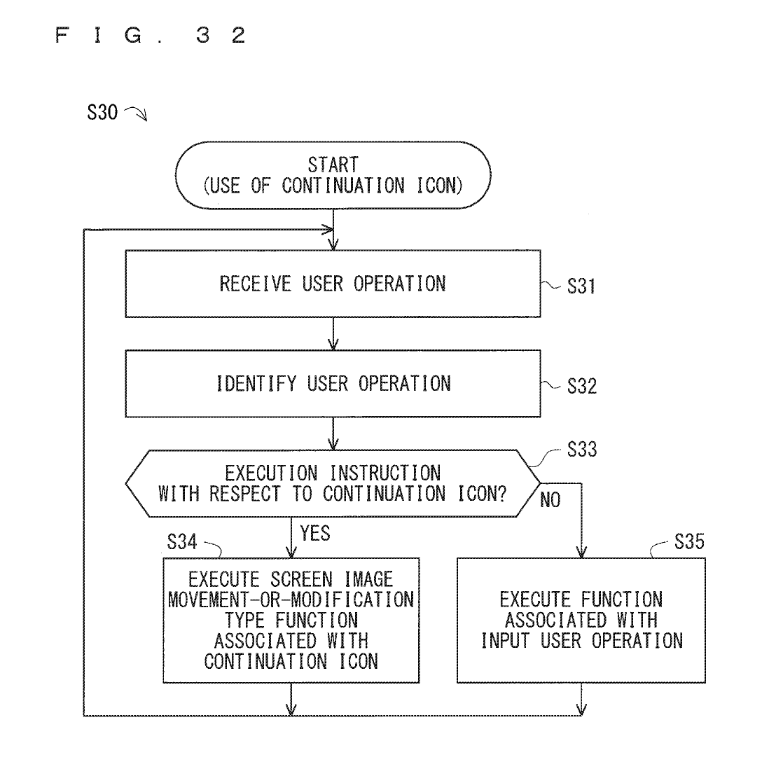

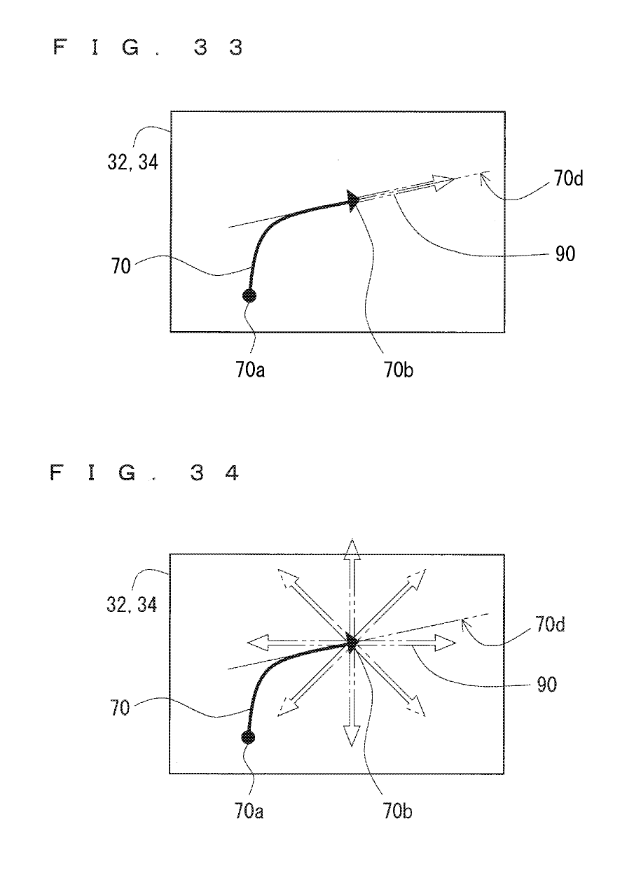

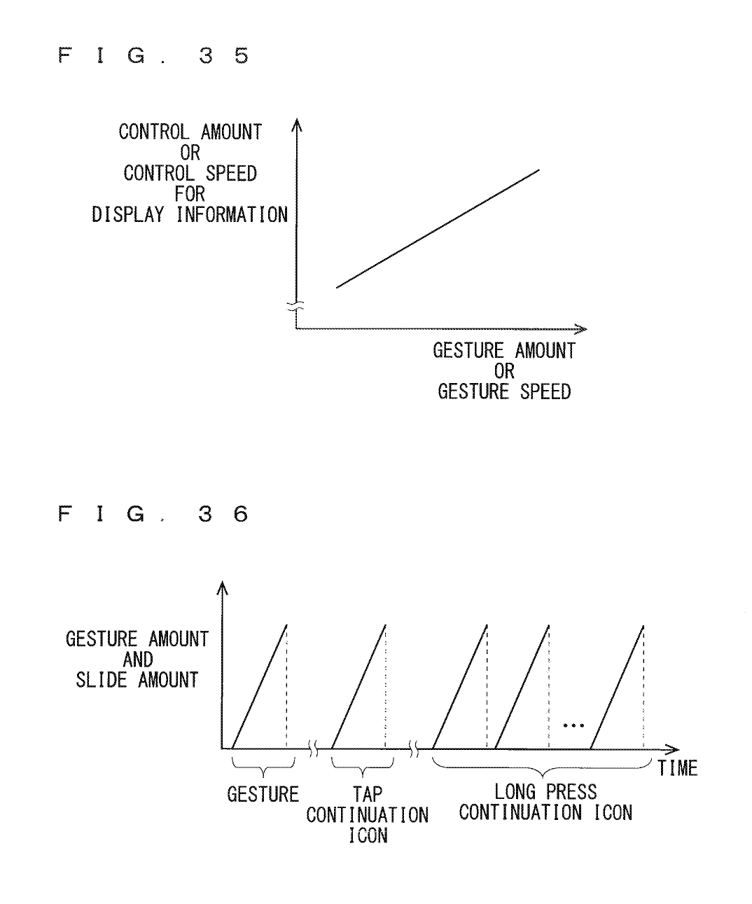

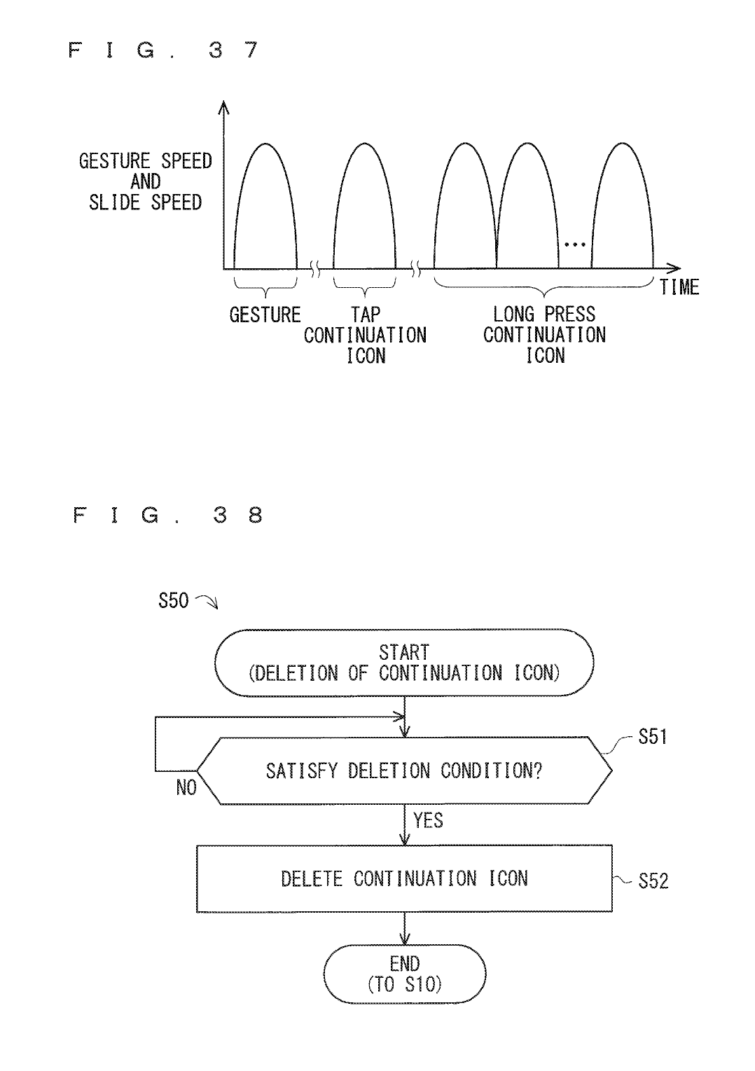

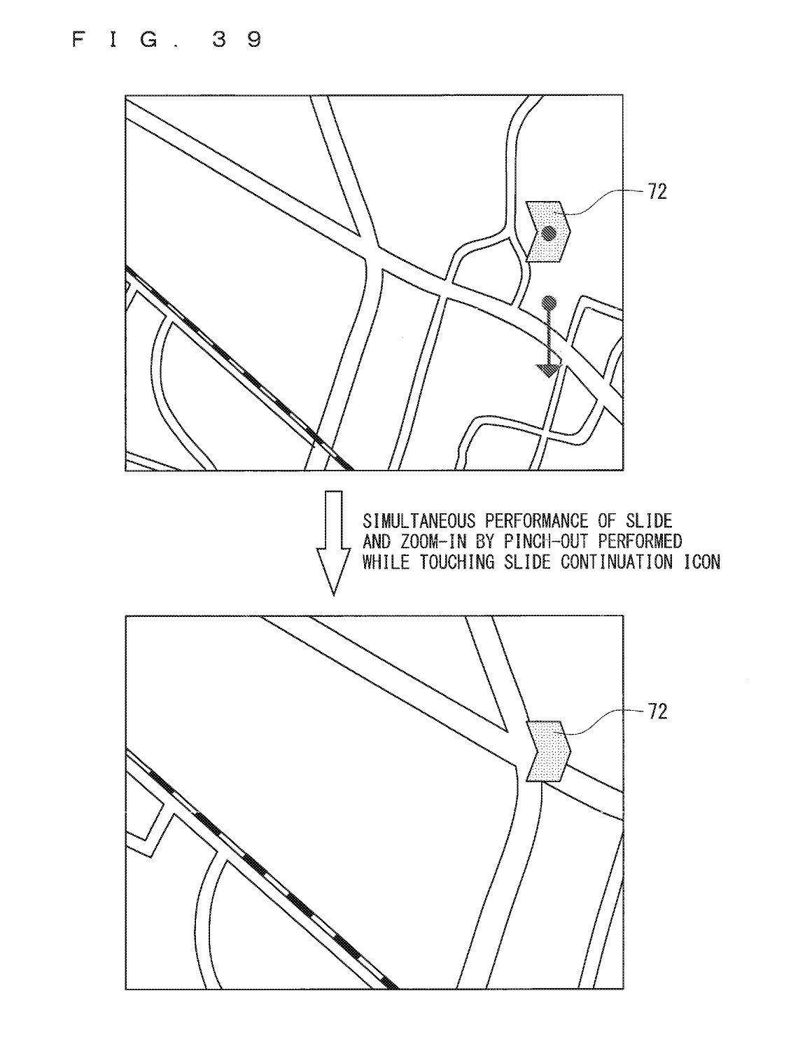

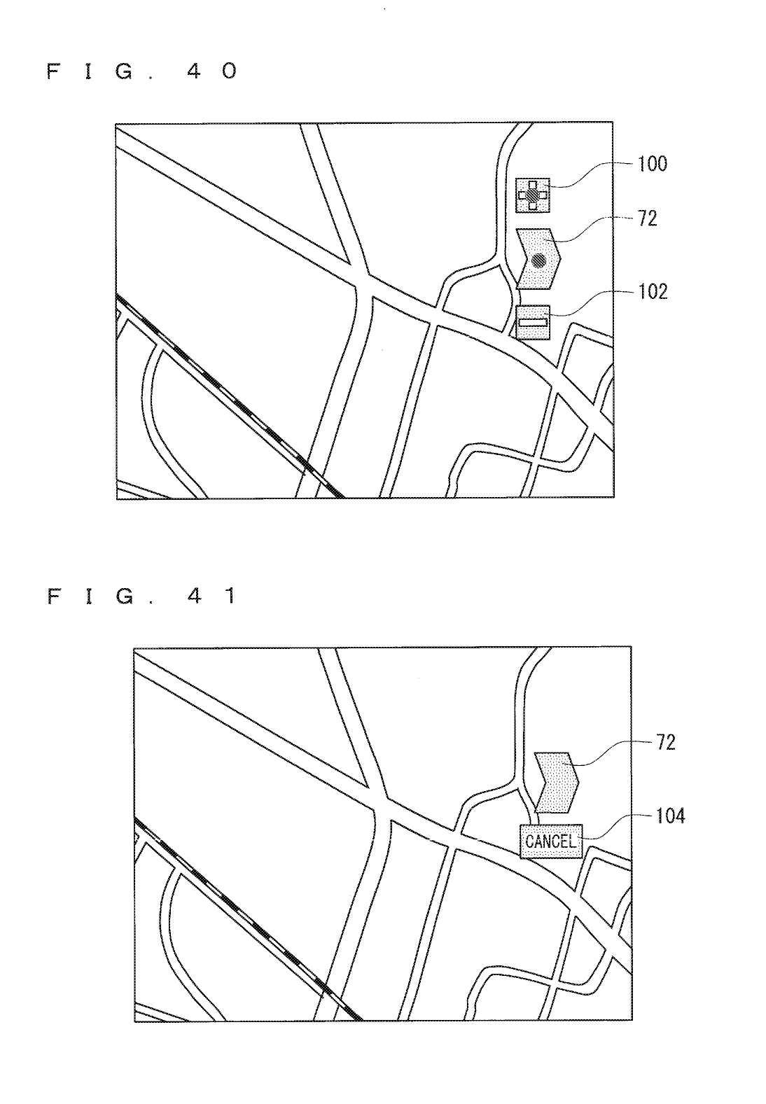

FIG. 4 is a conceptual diagram of a double-point touch operation (also simply referred to as a “double-point touch”) as Example 2 of the touch operation. The double-point touch is basically similar to the single-point touch except for using two fingers. Therefore, the double-point touch can also achieve the operations including the tap, the multiple tap, and the long press. The double-point touch may be achieved by using two fingers of one hand, or one finger of the right hand and one finger of the left hand. A relation between the positions of the two fingers is in no way limited to that in the example of FIG. 4.

The touch operation may be performed with three or more fingers.

FIG. 5 is a conceptual diagram of a drag operation (also simply referred to as a “drag”) as Example 1 of the gesture operation. The drag refers to an operation of shifting a fingertip while placing the fingertip on the input surface 34. A direction of movement of the finger and a distance of movement of the finger are in no way limited to those in the example of FIG. 5.

In FIG. 5, a start point of the movement of the finger is schematically shown by a black circle, an end point of the movement of the finger is schematically shown by a black triangle, the direction of the movement of the finger is represented by a direction to which the triangle points, and a track is represented by a line connecting the black circle and the black triangle. The same illustration method is applied to the drawings described later. The black circle, the block triangle, and the track may actually be displayed on the display surface.

FIG. 6 is a conceptual diagram of a flick operation (also simply referred to as a “flick”) as Example 2 of the gesture operation. The flick refers to an operation of wiping the input surface 34 quickly with the fingertip. A direction of movement and a distance of movement of the finger are in no way limited to those in the example of FIG. 6.

The flick is different from the drag in that the finger is released from the input surface 34 during movement. Since the touch panel 14 is of a contact type, movement of the finger after the finger is released from the input surface 34 is not detected herein, in principle. However, a speed of the movement of the finger at a point at which the finger is last detected can be calculated from a change of a set of coordinate data acquired during the movement of the finger on the input surface 34. The flick is distinguishable by the fact that the calculated speed of the movement is equal to or higher than a predetermined threshold (referred to as a “drag/flick distinguishing threshold”).

Similarly, a point at which the finger eventually arrives after being released from the input surface 34 (more specifically, a point obtained by projecting the point onto the input surface 34) can be estimated from the direction, the speed, and the acceleration of the movement of the finger at the point at which the finger is last detected, for example. The estimate processing can be construed as processing to convert the flick into a virtual drag.

The information display device 10 therefore handles the point as estimated above as an end point of the movement of the finger. In this example, the above-mentioned estimate processing may be performed by the touch panel 14 or by the controller 16.

The information display device 10, however, may be modified so as to handle a point at which the finger is released from the input surface 34 as an end point of the movement of the finger without performing the above-mentioned estimate processing.

FIG. 7 is a conceptual diagram of a pinch-out operation (also simply referred to as a “pinch-out”) as Example 3 of the gesture operation. The pinch-out refers to an operation of moving two fingers away from each other on the input surface 34. The pinch-out is also referred to as a “pinch open”.

In FIG. 7, an example in which both of the two fingers are dragged is illustrated. As illustrated as Example 4 of the gesture operation in FIG. 8, the pinch-out may also be achieved by fixing one of the two fingers onto the input surface 34 (i.e., remaining touching the input surface 34 with the one of the two fingers), and dragging only another one of the two fingers. When the operations illustrated in FIGS. 7 and 8 are distinguished from each other, the operation illustrated in FIG. 7 is referred to as a “a double-point movement type” operation, and the operation illustrated in FIG. 8 is referred to as a “single-point movement type” operation.

FIG. 9 is a conceptual diagram of a pinch-in operation (also simply referred to as a “pinch-in”) as Example 5 of the gesture operation. The pinch-in refers to an operation of moving two fingers toward each other on the input surface 34. The pinch-in is also referred to as a “pinch close”. Although a double-point movement type pinch-in is illustrated in FIG. 9, a single-point movement type pinch-in is illustrated in FIG. 10 as Example 6 of the gesture operation.

The pinch-out and the pinch-in are herein collectively referred to as a “pinch operation” or a “pinch”, and a direction of movement of the finger is referred to as a “pinch direction”. In this case, when the pinch direction is a direction in which a distance between the fingers increases, the pinch operation is particularly referred to as the pinch-out. On the other hand, when the pinch direction is a direction in which the distance between the fingers decreases, the pinch operation is particularly referred to as the pinch-in.

The pinch-out and the pinch-in may be achieved by using two fingers of one hand, or one finger of the right hand and one finger of the left hand. A relation between the positions of the two fingers, and a direction and a distance of the movement of the two fingers are in no way limited to those in the examples of FIGS. 7-10. In the single-point movement type pinch-out and pinch-in, one of the two fingers used for the drag is in no way limited to those in the examples of FIGS. 8 and 10. The pinch-out and the pinch-in can be achieved by using the flick in place of the drag.

Each user operation is associated with a specific function. Specifically, upon detection of a user operation, the controller 16 performs processing associated with the user operation, thereby achieving a corresponding function. In view of the above, the user operation can be classified by the function achieved by the user operation.

For example, a double tap performed with respect to an icon on the display surface 32 is associated with a function of executing a program or a command associated with the icon. In this case, the double tap serves as an execution instruction operation.

As illustrated in FIG. 11, a drag performed with respect to display information (a map image is illustrated in FIG. 11) is associated with a slide function of sliding the display information. In this case, the drag operation serves as a slide operation. The slide may be achieved by the flick in place of the drag.

As illustrated in FIG. 12, a pinch-out and a pinch-in performed with respect to display information (a map image is illustrated in FIG. 12) are associated with a function of changing a size (i.e., a scale) of the display information. In this case, the pinch-out and the pinch-in serve as a display size change operation (may also be referred to as a “display scale change operation”). More specifically, the pinch-out and the pinch-in correspond to a zoom-in operation and a zoom-out operation, respectively, in the example of FIG. 12.

As illustrated in FIG. 13, a drag performed with respect to display information (a map image is illustrated in FIG. 13) so as to draw a circle with two fingers while maintaining a distance therebetween is associated with a function of rotating the display information. In this case, the double-point movement type rotational drag serves as a rotation operation. A rotational drag may be performed with three or more fingers. The function associated with the rotational drag may vary depending on the number of fingers used to perform the rotational drag.

A plurality of functions may be assigned to a single user operation. For example, a double tap may be assigned to a folder opening operation of opening a folder associated with an icon in addition to the above-mentioned execution instruction operation. Similarly, a drag may be assigned to a slide function and a drawing function. When a plurality of functions are assigned to a single user operation, the functions are switched in accordance with a target of an operation, a use status (i.e., a use mode), and the like.

Alternatively, a plurality of user operations may be assigned to a single function. For example, an execution instruction function executed with respect to an icon may be associated with a double tap, a long press, and a flick. In this case, a program and the like associated with the icon can be executed by any of the double tap, the long press, and the flick. Similarly, a slide function may be associated with both of a drag and a flick, for example. Furthermore, a rotation function may be associated with both of a double-point movement type rotational drag and a single-point movement type rotational drag, for example.

A function associated with a user operation is roughly classified into a screen image movement-or-modification type function and a non-movement-or-modification type function from a perspective of movement and modification of a screen image. A gesture operation associated with the screen image movement-or-modification type function is hereinafter also referred to as a “gesture operation for the screen image movement-or-modification type function”, for example.

The screen image movement-or-modification type function associated with the gesture operation is a function of controlling (i.e., handling) display information on the display surface in a control direction set in accordance with a gesture direction. The screen image movement-or-modification type function includes a slide function, a display size change function, a rotation function, and a bird's eye-view display function (more specifically, a function of changing an elevation-angle and a depression-angle), for example. The slide function can be classified as a screen image movement function. The rotation function can be classified as the screen image movement function when the rotation function is viewed from a perspective of movement of an angle. The display size change function and the bird's eye-view display function can each be classified as a screen image modification function.

More specifically, the slide function is achieved by setting a slide direction (i.e., a control direction) in accordance with a gesture direction (e.g. a drag direction or a flick direction), and sliding display information in the slide direction.

The display size change function is achieved by setting the control direction to a zoom-in direction when the gesture direction (e.g. a pinch direction) is the zoom-in direction, or setting the control direction to a zoom-out direction when the gesture direction is the zoom-out direction, and changing a size of display information in the control direction thus set.

The rotation function is achieved by setting the control direction to a clockwise-rotation direction when the gesture direction (e.g. a rotation direction in the rotational drag) is the clockwise-rotation direction, or setting the control direction to a counterclockwise-rotation direction when the gesture direction is the counterclockwise-rotation direction, and rotating display information in the control direction thus set.

The screen image movement-or-modification type function may control display information by using not only the gesture direction but also a gesture amount (e.g. the length of a gesture track). Specifically, a control amount (e.g. a slide amount, a display size change amount, and a rotation amount) for display information may be set to be larger as the gesture amount increases.

The screen image movement-or-modification type function may control display information by using a gesture speed in addition to or in place of the gesture amount. Specifically, a control speed (e.g. a slide speed, a display size change speed, and a rotation speed) for display information may be set to be higher as the gesture speed increases.

In contrast, the non-movement-or-modification type function is achieved without using the gesture direction even when the non-movement-or-modification type function is associated with the gesture operation. For example, even when a flick performed with respect to an icon is associated with an execution instruction function for executing a specific program, the function belongs to the non-movement-or-modification type function. When a drag is used for executing a drawing function and a handwritten character input function, for example, only a track of the drag is displayed, and display information is not controlled in accordance with a direction of the drag.

The user operation and the function achieved by the user operation are in no way limited to those in the examples as described above.

<Continuation Icon>

The information display device 10 uses a continuation icon, which is characteristic operation technique. The continuation icon is displayed on the display surface when a gesture operation for a screen image movement-or-modification type function is performed. When an execution instruction operation is performed with respect to the continuation icon, the screen image movement-or-modification type function that is associated with the gesture operation involved in appearance of the continuation icon (i.e., the gesture operation that triggers display of the continuation icon) is executed. In other words, the continuation icon is associated with the screen image movement-or-modification type function that is associated with the gesture operation involved in appearance of the continuation icon. A control direction for display information when the screen image movement-or-modification type function is executed via the continuation icon is set so as to be the same as a control direction of the gesture operation involved in appearance of the continuation icon.

An example of the execution instruction operation with respect to the continuation icon is a single-point touch operation. For example, a screen image movement-or-modification type function associated with a continuation icon may be continued to be executed while the continuation icon is being touched. In this case, a control amount (e.g. a slide amount) for the screen image movement-or-modification type function becomes larger by a long press than by a tap operation. However, it is not limited to this example. For example, the screen image movement-or-modification type function may be continued to be executed while taps are continuously performed.

FIG. 14 is a conceptual diagram of a slide continuation icon associated with a slide function as an example of the continuation icon. A drag 70 as an example of the gesture operation is herein associated with the slide function as an example of the screen image movement-or-modification type function. A slide continuation icon 72 is displayed by performing the drag 70. The slide continuation icon 72 receives an instruction to execute the slide function. A slide direction with the slide continuation icon 72 is set to be the same as a slide direction of the drag 70 that is involved in appearance of the continuation icon 72.

In the example of FIG. 14, by performing a drag to the right, a map image is slid to the right, and a subsequent map image appears from a left-hand side of the display surface. In this case, the slide direction is the same as the drag direction, i.e., to the right. In view of the above, the slide continuation icon 72 is designed in imitation of the head of a right arrow in the example of FIG. 14. The design of the slide continuation icon 72, however, is not limited to the illustrated example. In the example of FIG. 14, the scroll direction of the map image is typically expressed as a left direction. That is to say, the control direction in the scroll function, i.e., the scroll direction, differs from the control direction of the slide function, i.e., the slide direction, by 180°. The scroll function and the slide function have in common in that the control direction is set in accordance with the gesture direction (the drag direction in the example of FIG. 14).

Continuation icons that receive the display size change function and the rotation function as other examples of the screen image movement-or-modification type function are referred to as a “display size change continuation icon” and a “rotation continuation icon”, respectively. More specifically, the display size change continuation icon is classified into two continuation icons, that is, a zoom-in continuation icon 80 and a zoom-out continuation icon 82, depending on a display size change direction as illustrated in FIGS. 15 and 16, respectively. The rotation continuation icon is classified into two continuation icons, that is, a clockwise-rotation continuation icon 84 and a counterclockwise-rotation continuation icon 86, depending on a rotation direction as illustrated in FIGS. 17 and 18, respectively. Designs of these continuation icons 80, 82, 84, and 86, however, are not limited to the illustrated examples.

According to the information display device 10, a continuation icon can be called onto the display surface by a gesture operation, and a screen image movement-or-modification type function associated with the above-mentioned gesture operation can be executed by using the continuation icon. Use of the continuation icon can thus reduce the number of times the gesture operation is repeated, leading to a reduction of an operational burden.

Furthermore, the continuation icon is displayed only by performing a gesture operation associated with a function desired to be executed. This means that the continuation icon is displayed automatically in accordance with a function intended by a user.

Moreover, the continuation icon is not called under a situation in which a user continues to view display information without performing any operation. Therefore, the display information is not covered with the continuation icon.

<Configuration Example of Controller 16>

FIG. 19 is a block diagram showing an example of the controller 16. For illustrative purposes, the display unit 12, the input unit 14, and the storage 18 are also shown in FIG. 19. According to the example of FIG. 19, the controller 16 includes an input analyzer 40, an overall controller 42, a first image formation unit 44, a first image holding unit 46, a second image formation unit 48, a second image holding unit 50, an image synthesizer 52, a synthesized image holding unit 54, and a continuation icon manager 56.

The input analyzer 40 analyzes a user operation detected by the input unit 14 to identify the user operation. Specifically, the input analyzer 40 acquires coordinate data detected in association with the user operation from the input unit 14, and acquires user operation information from the coordinate data. The user operation information is information on a type of the user operation, a start point and an end point of finger movement, a track from the start point to the end point, a direction of the movement, an amount of the movement, a speed of the movement, an acceleration of the movement, and the like.

As for identification of the type of the user operation, a touch operation and a gesture operation can be distinguished from each other by comparing, for example, a distance between the start point and the end point to a predetermined threshold (referred to as a “touch/gesture distinguishing threshold”). A drag and a flick can be distinguished from each other by a speed of finger movement at the end of the track, as described previously.

When two drags are identified simultaneously, a pinch-out and a pinch-in can be distinguished from each other by a direction of movement. When two drags are performed so as to draw a circle while maintaining a distance therebetween, a rotational drag can be identified. When a drag and a single-point touch are identified simultaneously, a single-point movement type pinch-out, pinch-in, or rotational drag can be identified.

The overall controller 42 performs various types of processing of the controller 16. For example, the overall controller 42 associates a position on the input surface of the input unit 14 with a position on the display surface of the display unit 12. As a result, a touch position in a touch operation, a gesture track in a gesture operation, and the like are associated with the display surface. By associating positions as described above, a position on the display surface intended by a user operation can be identified. Such association is enabled by so-called graphical user interface (GUI) technology.

The overall controller 42 identifies a function desired by a user, i.e., a user instruction, based on user operation information and function identification information, for example. The function identification information is information for defining association between user operations and functions to execute via operation status information. The operation status information is information on a use status (i.e., a use mode) of the information display device 10, an operation target of a user operation, a type of a user operation that can be received in accordance with the use status and the operation target, and the like.

More specifically, when a drag is performed with respect to a map image as an operation target under a situation in which map viewing software is used, for example, the drag is identified as an instruction to execute a slide function. When a tap is performed with respect to a zoom-in icon on the map image as an operation target, for example, the tap is identified as an instruction to execute a display size increase function. When a flick performed with respect to a zoom-in icon is not associated with any function, the flick is identified as an invalid operation.

The overall controller 42 also controls display information on the display surface by controlling the first image formation unit 44, the second image formation unit 48, and the image synthesizer 52. Display information is changed based on a result of identification of a user instruction, or based on an instruction in executing a program regardless of the result of identification of the user instruction.

The overall controller 42 also performs overall control on the other functional units 40, 44, 46, 48, 50, 52, 54, and 56, e.g., adjustment of an execution timing.

The first image formation unit 44 reads, from the storage 18, first information 60 in accordance with an instruction from the overall controller 42, forms a first image from the first information 60, and stores the first image in the first image holding unit 46. Similarly, the second image formation unit 48 reads, from the storage 18, second information 62 in accordance with an instruction from the overall controller 42, forms a second image from the second information 62, and stores the second image in the second image holding unit 50.

The image synthesizer 52 reads the first image from the first image holding unit 46, reads the second image from the second image holding unit 50, synthesizes the first image and the second image, and stores the synthesized image in the synthesized image holding unit 54 upon instructed by the overall controller 42.

The images are synthesized so that the first image and the second image are superimposed. An example in which the first image is a lower image (i.e., a lower layer) and the second image is an upper image (i.e., an upper layer) is described herein. “Upper” and “lower” correspond to a difference in a normal direction of the display surface, and a layer that is located closer to a user who views the display surface is expressed as an “upper” layer. Image data is actually superimposed based on such a concept.

In the synthesized image, i.e., a display screen, a lower image is displayed in a transparent portion of the upper image. In other words, a drawing portion of the upper image covers the lower image. By setting transparency of the drawing portion of the upper image, however, a synthesized image in which a lower image is viewed through the upper image can be formed.

Setting of one of the first image and the second image to be adopted as the upper image may be unchangeable or may be changeable.

Although an example in which two layers composed of the first image and the second image are synthesized is described herein, a configuration in which more layers can be synthesized may be used. Alternatively, another synthesis method may be used.

The synthesized image stored in the synthesized image holding unit 54 is transferred to the display unit 12, and displayed by the display unit 12. By updating the synthesized image, i.e., by updating at least one of the first image and the second image, the display screen is changed.

The continuation icon manager 56 manages display of the continuation icon under control of the overall controller 42. Specifically, the continuation icon manager 56 manages information on a display position, a size, an orientation, a display attribute, and the like, and controls the second image formation unit 48 and the image synthesizer 52 based on the managed information, thereby managing display of the continuation icon.

For example, the continuation icon manager 56 instructs the second image formation unit 48 to read image data of the continuation icon from the storage 18, to form an image of the continuation icon having a size determined in accordance with a size of the display surface and the like, to draw the image of the continuation icon as formed on a transparent plane in accordance with a display position and an orientation, and to store the drawn image in the second image holding unit 50. As for deletion of the continuation icon, the continuation icon manager 56 instructs the second image formation unit 48 to store an image not including the image of the continuation icon in the second image holding unit 50. The continuation icon manager 56 also instructs the image synthesizer 52 to synthesize images stored in the image holding units 46 and 50.

<Examples of Processing Performed by Information Display Device 10>

The following describes examples of processing (i.e., a display information operation method) that is associated with the continuation icon and performed by the image display device 10.

<Display of Continuation Icon>

FIG. 20 shows an example of a processing flow S10 to display the continuation icon. According to the example of FIG. 20, the input unit 14 receives a user operation in step S11, and the controller 16 identifies the input user operation in step S12. In step S13, the controller 16 executes a function associated with the user operation based on a result of the identification in step S12.

Then, in step S14, the controller 16 judges whether or not the user operation received in step S11 satisfies a condition set beforehand to display the continuation icon (referred to as a “continuation icon display start condition” or a “display start condition”). When it is judged that the display start condition is not satisfied, processing performed by the information display device 10 returns to the above-mentioned step S11. When it is judged that the display start condition is satisfied, the controller 16 performs processing to display the continuation icon in step S15. After display of the continuation icon, the processing flow S10 of FIG. 20 ends.

<Continuation Icon Display Start Condition>

As for the above-mentioned step S14, a condition (referred to as a “single-operation condition”) that the continuation icon is displayed when a gesture operation for a screen image movement-or-modification type function (i.e., a gesture operation that triggers display of the continuation icon) is executed once can be used as the continuation icon display start condition. According to the single-operation condition, the continuation icon can immediately be used. Therefore, an operational burden of repeating the same gesture operation a number of times can be reduced.

A condition (referred to as an “operation duration condition”) that the continuation icon is displayed when the duration of a single operation of a gesture operation for a screen image movement-or-modification type function reaches a predetermined threshold (referred to as an “operation duration threshold”) may be added to the single-operation condition. When a single operation of a gesture operation takes some time, a user is expected to have performed the gesture operation while closely watching display information, for example. The gesture operation is thus likely to be further repeated. Therefore, according to the operation duration condition, the continuation icon can be displayed while identifying a user's intention more precisely.

Furthermore, a condition (referred to as an “operation speed condition”) that the continuation icon is displayed when a speed of a single operation of a gesture operation for a screen image movement-or-modification type function is equal to or higher than a predetermined threshold (referred to as an “operation speed threshold”) may be added to the single-operation condition. When a gesture operation is performed quickly, a user is expected to have desired to immediately view display information displayed after the operation, for example. The gesture operation is thus likely to be further repeated. Therefore, according to the operation speed condition, the continuation icon can be displayed while identifying a user's intention more precisely.

In the operation speed condition, a display timing may be defined. That is to say, the operation speed condition may be modified to a condition that the continuation icon is displayed at a timing earlier than a predetermined icon display timing when the speed of a single operation of a gesture operation for the screen image movement-or-modification type function is equal to or higher than the operation speed threshold. The continuation icon can thereby promptly be provided.

Furthermore, a condition (referred to as a “gesture amount condition”) that the continuation icon is displayed when an amount of a single operation of a gesture operation (e.g. a drag distance) for a screen image movement-or-modification type function is equal to or higher than a predetermined threshold (referred to as a “gesture amount threshold”) may be added to the single-operation condition. When an amount of a gesture operation is large, a user is expected to have desired a large amount of control with respect to display information, for example. The gesture operation is thus likely to be further repeated. Therefore, according to the gesture amount condition, the continuation icon can be displayed while identifying a user's intention more precisely.

Furthermore, a condition (referred to as an “end point condition”) that the continuation icon is displayed when an end point of a gesture operation for a screen image movement-or-modification type function corresponds to a point in a predetermined area on the display surface may be added to the single-operation condition. An example of the above-mentioned predetermined area on the display surface is a peripheral area 32b of the display surface 32 as illustrated in FIG. 21. According to the example of FIG. 21, the peripheral area 32b of the display surface 32 corresponds to a peripheral area 34b of the input surface 34, and an end point 70b of the drag 70 exists in the peripheral areas 32b and 34b. The continuation icon (e.g. the slide continuation icon) is displayed upon occurrence of such a situation. A user is expected to have reached the peripheral areas 32b and 34b against the user's wish to continue a drag, for example. Furthermore, a user can intentionally use the end point condition to display the continuation icon, for example. Therefore, according to the end point condition, the continuation icon can be displayed while identifying a user's intention more precisely. The above-mentioned predetermined area is in no way limited to the peripheral areas 32b and 34b. The drag illustrated in FIG. 21 may be one of drags of a double-point movement type pinch-out, for example.

Furthermore, a condition (referred to as a “call operation condition”) that the continuation icon is displayed when a gesture operation for a screen image movement-or-modification type function is followed by a continuation icon call operation may be added to the single-operation condition. This condition that “ . . . is followed by . . . ” includes a condition that the gesture operation and the continuation icon call operation are performed with an interval that is equal to or shorter than a predetermined operation time interval and a condition that no other operation is performed between the gesture operation and the continuation icon call operation.

An example of the continuation icon call operation is a touch operation.

More specifically, as illustrated in FIG. 22, an operation of touching, without releasing a finger with which a drag as the above-mentioned gesture operation has been performed, any other point on the input surface with another finger may be used as the continuation icon call operation. As the touch operation, a tap, a double tap, or a long press may be used. The touch operation can be performed when the above-mentioned gesture operation is an operation using a plurality of fingers, such as a pinch-out.

Alternatively, as illustrated in FIG. 22, an operation of touching an end point of a drag performed as the above-mentioned gesture operation or a point near the end point may be used as the continuation icon call operation. As the touch operation, a tap or a double tap may be used. The touch operation can be performed when the above-mentioned gesture operation is a flick and when the above-mentioned gesture operation is an operation using a plurality of fingers, such as a pinch-out. A long press may be used as the touch operation performed after a drag. In this case, the drag transitions to the long press without releasing the finger with which the drag is performed from the input surface. The continuation icon call operation achieved by the long press can be performed when the above-mentioned gesture operation is an operation using a plurality of fingers, such as a pinch-out.

As the continuation icon call operation, a flick operation may be used in place of the touch operation. Specifically, as illustrated in FIG. 22, a flick is performed so as to follow the track of the drag.

The continuation icon call operation can suppress accidental display of the continuation icon.

Furthermore, a condition (referred to as a “non-operating state continuation condition”) that the continuation icon is displayed when a non-operating state continues for a time period (a time length) that is equal to or longer than a predetermined time period after the gesture operation for a screen image movement-or-modification type function may be added to the single-operation condition. According to the non-operating state continuation condition, the continuation icon is not immediately displayed, thereby contributing to prevention of an operation error.

Any of the above-mentioned conditions, such as the operation duration condition, may be combined to each other.

A condition (referred to as a “repetition operation condition”) that the continuation icon is displayed when a gesture operation for a screen image movement-or-modification type function is continuously repeated in the same gesture direction a predetermined number of times may be used as the continuation icon display start condition. The condition that “ . . . in same gesture direction . . . ” herein includes not only a case where the gesture operation is repeated in exactly the same gesture direction but also a case where the gesture operation is repeated in substantially the same direction (e.g. a case where a variation in gesture direction in each repetition falls within a predetermined allowable range). The condition that “ . . . continuously . . . ” includes a condition that the gesture operation is repeated at an interval that is equal to or shorter than a predetermined operation time interval and a condition that no other operation is performed during repetition of the gesture operation.

A condition that similar gesture operations (e.g. a drag and a flick) are handled as the same gesture operation may be added to the repetition operation condition.

As for the repetition operation condition, repetition of the same gesture operation can be detected, for example, by monitoring a type of the gesture operation, a gesture direction, the number of times a loop processing in steps S11-S14 is repeated, and the like in step S14 (see FIG. 20).

When a user repeats a gesture operation, the gesture operation is likely to be further repeated. Therefore, according to the repetition condition, the continuation icon can be displayed while identifying a user's intention more precisely.

A condition (referred to as a “total repetition duration condition”) that the continuation icon is displayed when the duration of repetition of the gesture operation reaches a predetermined threshold (referred to as a “total repetition duration threshold”) may be added to the repetition operation condition. When repetition of a gesture operation takes some time, a user is expected to have desired to immediately view subsequent display information, for example. The gesture operation is thus likely to be further repeated. Therefore, according to the total repetition duration condition, the continuation icon can be displayed while identifying a user's intention more precisely.

A condition (referred to as a “repetition speed condition”) that the continuation icon is displayed when a speed of repetition of a gesture operation for a screen image movement-or-modification type function is equal to or higher than a predetermined threshold (referred to as a “repetition speed threshold”) may be added to the repetition operation condition. The repetition speed is defined as the number of times a gesture operation is repeated per unit time. When a gesture operation is repeated quickly, a user is expected to have desired to immediately view subsequent display information, for example. The gesture operation is thus likely to be further repeated. Therefore, according to the repetition speed condition, the continuation icon can be displayed while identifying a user's intention more precisely.

In the repetition speed condition, a display timing may be defined. That is to say, the repetition speed condition may be modified to a condition that the continuation icon is displayed at a timing earlier than a predetermined icon display timing when the speed of repetition of a gesture operation for the screen image movement-or-modification type function is equal to or higher than the repetition speed threshold. The continuation icon can thereby promptly be provided.

Furthermore, a condition (referred to as a “total gesture amount condition”) that gesture amounts (e.g. drag distances) are integrated as a gesture operation for a screen image movement-or-modification type function is repeated, and the continuation icon is displayed when a value of the integration reaches a predetermined threshold (referred to as a “total gesture amount threshold”) may be added to the repetition operation condition. When the value of the integration of the gesture amounts is high, a user is expected to have desired a large amount of control with respect to display information, for example. The gesture operation is thus likely to be further repeated. Therefore, according to the total gesture amount condition, the continuation icon can be displayed while identifying a user's intention more precisely.

Any of the above-mentioned conditions, such as the total repetition duration condition, may be combined to each other.

Furthermore, one or more of the above-mentioned conditions, such as the operation duration condition, described in relation to the single-operation condition may be added to the repetition operation condition. Specifically, one or more of the above-mentioned conditions, such as the operation duration condition, are applied to each gesture operation included in the repetition. Alternatively, one or more of the above-mentioned conditions, such as the operation duration condition, may be applied to a predetermined gesture operation included in the repetition (e.g. the last gesture operation). The precision of identification of a user's intention can be improved by the additional condition as described above.

<Display Position of Continuation Icon>

As for the above-mentioned step S15 (see FIG. 20), the continuation icon may basically be displayed at any position. When the slide continuation icon 72 exists near the end point 70b of the drag 70 as illustrated in FIG. 23, however, the finger with which the drag 70 is performed can be moved onto the slide continuation icon 72 with a small amount of movement.

In the example of FIG. 23, the continuation icon 72 is located in the right side of the end point 70b of the drag. The continuation icon 72, however, may be located in the other side of the end point 70b or located directly above the end point 70b. In view of the above, the above-mentioned advantageous effect can be obtained when the continuation icon 72 exists within an area (referred to as an “end point area”) 70c that is defined so as to include the end point 70b, as illustrated in FIG. 23.

A size and a shape of the end point area 70c may vary in accordance with an operation status (e.g. a size of a finger as detected, a speed of movement of a finger), or may be fixed independently of the operation status. The center of the end point area 70c may not necessarily coincide with the end point 70b.

The end point area 70c can be obtained in a coordinate system on the display surface after associating the end point 70b of the drag 70 with the display surface. Alternatively, the end point area 70c may be obtained in a coordinate system on the input surface before associating the end point 70b of the drag 70 with the display surface, and the end point area 70c thus obtained may be associated with the coordinate system on the display surface.

When the above-mentioned repetition operation condition is applied, an average position of an end point may be obtained from all or part of gesture operations targeted for determination of the repetition operation condition, and the end point area 70c may be set based on the obtained end point. Alternatively, the end point area 70c may be set for a predetermined gesture operation included in the repetition (e.g. the last gesture operation).

Alternatively, as illustrated in FIG. 24, the continuation icon 72 may be located on an extended line 70d from the track of the drag 70. This provides smooth movement of a finger, as a finger with which the drag 70 has been performed can reach the continuation icon 72 only by moving in the same direction.

Alternatively, as illustrated in FIG. 25, the continuation icon 72 may be displayed on the extended line 70d in the above-mentioned end point area 70c.

Alternatively, as illustrated in FIG. 26, the continuation icon 72 may be displayed on the above-mentioned extended line 70d in the peripheral area 32b of the display surface 32. This prevents display information at the center of the display surface, which is considered to receive much user's attention, from being covered with the continuation icon 72. Although an example in which a range of setting the peripheral area 32b is the same as that of the above-mentioned FIG. 21 (relating to the end point condition of the continuation icon display start condition) is shown herein, the range of setting the peripheral area 32b is in no way limited to this example.

The following describes examples of a method for obtaining the above-mentioned extended line 70d, with reference to FIGS. 27-29. Although FIGS. 27-29 illustrate curved tracks of drags, the following description is also applicable to a linear track of a drag.

According to the example of FIG. 27, the extended line 70d is determined as a straight line connecting two points on the track of the drag. FIG. 27 illustrates a case where the two points on the track are the start point 70a and the end point 70b of the drag 70, but the two points are not limited to those shown in this example. For example, the end point 70b of the drag 70 and a point other than the end point 70b may be used as illustrated in FIG. 28.

According to the example of FIG. 29, the extended line 70d is determined as a straight line that is in contact with a point on the track of the drag. FIG. 29 illustrates a case where the point on the track is the end point 70b of the drag 70, but the point is not limited to that shown in this example.

The extended line 70d can easily be obtained by these methods.

It is preferable to set the extended line 70d by using an end point-side portion 70f of the track of the drag, i.e., by excluding a start point-side portion 70e of the track of the drag, as illustrated in the examples of FIGS. 28 and 29. In the examples of FIGS. 28 and 29, the track of the drag is divided into the start point-side portion 70e, which includes the start point 70a of the track, and the end point-side portion 70f, which includes the end point 70f of the track.

A user's intention is considered to be clearer in the end point-side portion 70f than in the start point-side portion 70e. For example, the tracks illustrated in FIGS. 28 and 29 appear to have changed directions during drags. Therefore, the continuation icon 72 can be displayed at a position reflecting the user's intention by using the end point-side portion 70f.

A part of the end point-side portion 70f other than the end point 70b can also be used. In view of the clarity of the user's intention, however, it is more preferable to set a straight line passing through the end point 70b and another point on the end point-side portion (see FIG. 28) or a tangent line to a track at the end point 70b (see FIG. 29) to the extended line 70d.

A smaller end point-side portion 70f compared to the start point-side portion 70e is considered to reflect more user's intention.

The extended line 70d can be obtained in a coordinate system on the display surface after associating the track of the drag 70 with the display surface. Alternatively, the extended line 70d may be obtained in a coordinate system on the input surface before associating the track of the drag 70 with the display surface, and the extended line 70d thus obtained may be associated with the coordinate system on the display surface.

When the above-mentioned repetition operation condition is applied, an average extended line may be obtained from all or part of gesture operations targeted for determination of the repetition operation condition, and the average extended line as obtained may be used as the above-mentioned extended line 70d. Alternatively, the extended line 70d for a predetermined gesture operation included in the repetition (e.g. the last gesture operation) may be used.

The above-mentioned various matters on the display position of the continuation icon are also applicable to a flick, and further to a pinch-out and the like because the pinch-out and the like include a drag.

In a double-point movement type gesture operation as illustrated in FIG. 30 (a pinch-out is illustrated in FIG. 30), the continuation icon (the zoom-in continuation icon 80 is illustrated in FIG. 30) may be provided for each of drags. In this example, a user should selectively operate one of the two continuation icons 80.

<Shape of Continuation Icon>

A larger continuation icon is easier to operate, contributing to prevention of an operation error. Since the continuation icon covers display information, however, it is preferable that the area of the continuation icon be smaller. Both of these requests can be satisfied by displaying the continuation icon 72 with a strip shape as illustrated in FIG. 31. Although the slide continuation icon 72 is illustrated in FIG. 31, the same applies to the other continuation icons.

The strip-shaped continuation icon can be used by preparing continuation icons having a plurality of shapes including the strip-shaped continuation icon in advance. Alternatively, a continuation icon having only one shape may be prepared in advance, and the second image formation unit 48 (see FIG. 19) may process the continuation icon into the strip shape when writing it into the second image holding unit 50.

The strip-shaped continuation icon may basically be displayed at any position. By displaying the strip-shaped continuation icon 72 along a part of the periphery of the display surface 32 as illustrated in FIG. 31, however, display information at the center of the display surface, which is considered to receive much user's attention, is prevented from being covered with the continuation icon 72.

<Display Attribute of Continuation Icon>

The continuation icon may be displayed by a different display attribute (i.e., a display style) from the other icons. For example, the continuation icon is displayed by a display attribute, such as blinking, stereoscopic display, animation display, and semi-transparent, or a combination of a plurality of display attributes. As a result, the visibility of the continuation icon increases, contributing to prevention of an operation error.

<Use of Continuation Icon>

FIG. 32 shows a processing flow S30 during display of the continuation icon. In the example of FIG. 32, steps S31 and S32 are respectively similar to steps S11 and S12 of FIG. 20. That is to say, the input unit 14 receives a user operation in step S31, and the controller 16 identifies the input user operation in step S32.

In step S33, the controller 16 judges whether or not the user operation received in step S31 is an execution instruction with respect to the continuation icon. Specifically, the controller 16 judges whether or not an input position of the user operation corresponds to a display position of the continuation icon, and also judges whether or not the user operation is an operation set in advance as the execution instruction operation with respect to the continuation icon (here, a single-point touch is shown as described above).

When it is judged that the user operation is the execution instruction with respect to the continuation icon in step S33, the controller 16 executes a screen image movement-or-modification type function that is associated with the continuation icon, i.e., a screen image movement-or-modification type function that is associated with a gesture operation involved in appearance of the continuation icon, in step S34. Processing performed by the information display device 10 then returns to the above-mentioned step S31.

When it is judged that the user operation is not the execution instruction with respect to the continuation icon in step S33, the controller 16 executes, in step S35, a function that is associated with the user operation received in step S31. Processing performed by the information display device 10 then returns to the above-mentioned step S31.

Even during display of the slide continuation icon, for example, a drag that is associated with a slide function is received in the above-mentioned step S31, and the slide is performed in the above-mentioned step S33. As a result, even during display of the slide continuation icon, fine adjustment of display information, a slide in a different direction, and the like can be achieved by a drag. The same applies to the continuation icon other than the slide continuation icon.

<Slide Direction>

As for the above-mentioned step S34, a control direction for display information when a screen image movement-or-modification type function is executed via a continuation icon is set to be the same as a control direction of a gesture operation involved in appearance of the continuation icon.

In the display size increase function, the control direction for the display information is a zoom-in direction. Similarly, in a display size decrease function, a clockwise-rotation function, and a counterclockwise-rotation function, the control direction for the display information is uniquely determined by a gesture direction. The slide function, however, has a degree of freedom in terms of setting of a slide direction as the control direction. The following describes examples of a method for setting the slide direction, with reference to FIGS. 33 and 34.

In the example of FIG. 33, a slide direction 90 is set to a direction of the extended line 70d from the track of the drag 70. According to this method, the slide direction 90 can be set to a direction as intended by a user.

In the example of FIG. 34, a direction that is the closest to the direction of the extended line 70d is extracted, as the slide direction 90, from a plurality of directions set so as to have an origin at the end point 70b of the track of the drag. The above-mentioned plurality of directions are radially set at equal angles, for example. FIG. 34 illustrates eight directions set at every 45°. According to this method, the influence of a shake of user's hands can be absorbed. In addition, processing load of the slide processing can be reduced.

In the examples of FIGS. 33 and 34, as in FIG. 29, which is used for description on the display position of the continuation icon, a tangent line at the end point 70b of the track of the drag is used as the extended line 70d. The extended line 70d, however, is in no way limited to this example, and various matters on the extended line 70d provided in the description on the display position of the continuation icon are also applicable to setting of the slide direction 90.

<Control Amount and Control Speed>

As for the above-mentioned step S34 (see FIG. 32), when a continuation icon is tapped, for example, a screen image movement-or-modification type function associated with the continuation icon is executed by a predetermined control amount at a predetermined control speed. Furthermore, while the continuation icon is being pressed, for example, the screen image movement-or-modification type function associated with the continuation icon is executed continuously. In this case, the control amount for the display information is determined by a time period for which the continuation icon is being pressed. The control speed for the display information may be a predetermined fixed speed, or may gradually increase.

A gesture amount or a gesture speed of a gesture operation involved in appearance of a continuation icon may be reflected in a control amount for display information when an execution instruction operation is performed with respect to the continuation icon. Similarly, the gesture amount or the gesture speed may be reflected in a control speed for the display information when the execution instruction operation is performed with respect to the continuation icon.

In the example of FIG. 35, the control amount or the control speed for the display information is set so as to increase with increasing gesture amount or gesture speed. More specifically, the slide amount is set so as to increase with increasing drag distance. Alternatively, the slide speed is set so as to increase with increasing drag distance. Alternatively, the slide amount is set so as to increase with increasing drag speed. Alternatively, the slide speed is set so as to increase with increasing drag speed. As the drag speed, an average speed or the maximum speed can be used, for example. The relation, however, is in no way limited to the linear relation shown in FIG. 35.

Alternatively, a gesture amount of a gesture operation involved in appearance of a continuation icon may be set to a unit of a control amount for display information, and the display information may be controlled intermittently by the unit when an execution instruction operation is performed with respect to the continuation icon. For example, as shown in FIG. 36, the display information is slid by the unit when the slide continuation icon is tapped once, and the display information is slid intermittently by the unit while the slide continuation icon is being pressed. According to this, a change of the display information can easily be checked.

A change of a gesture speed of a gesture operation (i.e., an acceleration of a gesture operation) may be reflected in a control speed for display information when an execution instruction operation is performed with respect to a continuation icon. For example, as shown in FIG. 37, a speed history of the gesture operation is reproduced once when a slide continuation icon is tapped once, and the speed history of the gesture operation is repeated while the slide continuation icon is being pressed. The gesture speed typically decreases at the start and at the end of the gesture operation, and thus a situation similar to the above-mentioned intermittent slide is provided. As a result, a change of the display information can easily be checked.

As for the control amount and the control speed, each of the above-mentioned examples is applicable to a gesture operation other than the drag and a screen image movement-or-modification type function other than the slide function.

When the touch panel 14 is configured to detect pressure applied to the input surface by a finger, at least one of the control amount and the control speed for the display information may be set so as to increase with increasing pressure applied to the continuation icon.

<Deletion of Continuation Icon>

FIG. 38 shows an example of a processing flow S50 concerning deletion (i.e., termination of display) of a continuation icon. According to the example of FIG. 38, in step S51, the controller 16 judges whether or not a predetermined condition (referred to as a “continuation icon deletion condition” or a “deletion condition”) set so as to delete the continuation icon is satisfied.

When it is judged that the deletion condition is satisfied, the controller 16 performs processing to delete the continuation icon from the display surface in step S52. Processing performed by the information display device 10 then returns to the above-mentioned processing flow S10 (see FIG. 20) before display of the continuation icon. When it is judged that the deletion condition is not satisfied, the processing performed by the information display device 10 returns to the above-mentioned step S51.

The processing flow S50 is executed in parallel with the processing flow S30 executed during display of the continuation icon. Specifically, step S51 is repeated until the continuation icon deletion condition is satisfied, and, when the continuation icon deletion condition is satisfied, step S52 is performed as an interrupt processing.

<Continuation Icon Deletion Condition>

A condition (referred to as an “operation waiting condition”) that the continuation icon is deleted from the display surface when a state in which an execution instruction operation with respect to the continuation icon is not input continues may be used as the continuation icon deletion condition. When the continuation icon is not used for some time, a user is unlikely to use the continuation icon for a while. Therefore, according to a deletion waiting time condition, a high convenience can be provided in terms of deletion of the continuation icon while identifying a user's intention more precisely.

A predetermined fixed value can be used as the length of a waiting time until the continuation icon is deleted. Alternatively, the length of the waiting time may be set based on a gesture speed and the like of a gesture operation involved in appearance of the continuation icon. For example, when a gesture operation is performed quickly, the gesture operation is likely to be further repeated as described above. That is to say, the continuation icon is likely to be used. Therefore, it is preferable to set a deletion waiting time to be long when a gesture speed is high.

Alternatively, a condition (referred to as a “deletion instruction condition”) that the continuation icon is deleted from the display surface when the user operation is a predetermined continuation icon deletion operation may be used as the continuation icon deletion condition. An operation (e.g. a flick performed with respect to the continuation icon) that is different from the execution instruction operation performed with respect to the continuation icon is assigned to the continuation icon deletion operation. According to the deletion instruction condition, the continuation icon can be deleted at any time a user likes.

Alternatively, both of the operation waiting condition and the deletion instruction condition may be used to further improve convenience.

<Number of Continuation Icons>

A plurality of continuation icons can be displayed concurrently. For example, a plurality of slide continuation icons having different slide directions may be displayed. Alternatively, a slide continuation icon, a zoom-in continuation icon, and a clockwise-rotation continuation icon may be displayed. In this case, the above-mentioned processing flows S10, S30, and S50 are managed in parallel for each of the continuation icons. The number of continuation icons displayed concurrently may be limited.

<Combination of Slide and Display Size Change>

FIG. 39 shows an example of an operation of simultaneously performing a slide and a display size change. In the example of FIG. 39, an execution instruction operation with respect to the slide continuation icon 72 is combined with a pinch-out operation that is an instruction for an increase in display size.

More specifically, when the slide continuation icon 72 is touched together with a point other than the slide continuation icon 72, the controller 16 judges that a combination operation is input. The controller 16 then identifies an operation of performing a drag or a flick with a finger with which the point other than the slide continuation icon 72 is touched while keeping a state in which the slide continuation icon 72 is touched (i.e., a single-point movement type pinch operation). In this case, a pinch-out and a pinch-in are distinguished from each other by a direction of the pinch operation.

As a result of the identification, the controller 16 judges that an instruction combined with a slide instruction is an instruction for an increase in display size, and performs the slide and the increase in display size simultaneously.

By performing a pinch-in in place of the pinch-out, the slide and a decrease in display size can be performed simultaneously.

Alternatively, as illustrated in FIG. 40, a display size increase operation may be an operation of touching a zoom-in icon 100 (one example of the display size change icon) displayed at a point other than the slide continuation icon 72. In this case, a double-point touch operation is performed with respect to the slide continuation icon 72 and the zoom-in icon 100.

The zoom-in continuation icon 80 (see FIG. 15) can be used as the zoom-in icon 100. That is to say, when the slide continuation icon 72 and the zoom-in continuation icon 80 are displayed concurrently, a double-point touch operation should be performed with respect to these icons 72 and 80.

Alternatively, a normal zoom-in icon that is different from the zoom-in continuation icon 80 may be displayed as the zoom-in icon 100 together with the slide continuation icon 72. That is to say, these two icons 72 and 100 are displayed as a set.

In the example of FIG. 40, a zoom-out icon 102 is provided as another example of the display size change icon. The zoom-out icon 102 may be the zoom-out continuation icon 82 (see FIG. 16) or may be a normal zoom-out icon.

In contrast to the example of FIG. 40, only one of the zoom-in icon 100 and the zoom-out icon 102 may be displayed. Designs of these icons 100 and 102 are in no way limited to those in the example of FIG. 40.

<Cancelation Operation>

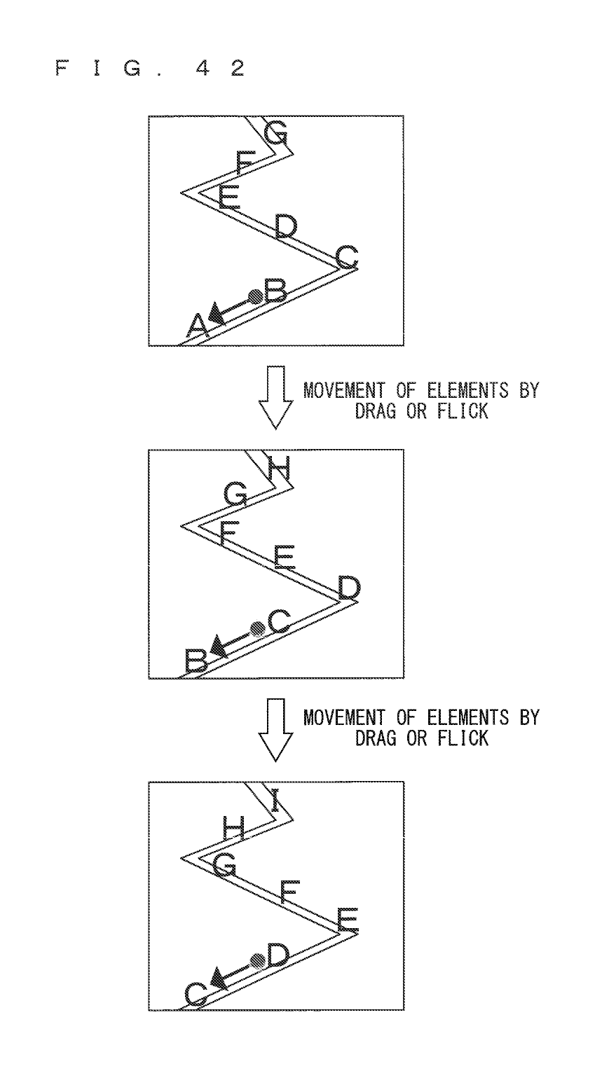

FIG. 41 illustrates a cancelation operation. According to the example of FIG. 41, a cancelation icon 104 is displayed together with the slide continuation icon 72 in step S15 (see FIG. 20). The cancelation icon 104 is an icon for canceling an execution instruction operation having been performed with respect to the slide continuation icon 72.

As a result, when a tap or a long press is performed as an execution operation with respect to the cancelation icon 104 (referred to as a “cancelation execution operation”) in step S31 of FIG. 32, for example, the controller 16 returns display information on the display surface to a state before a slide is performed by using the slide continuation icon 72 in steps S32, S33, and S35. For example, by setting a slide direction (i.e., a control direction) set for the slide continuation icon 72 to an opposite direction to execute the slide function, the display information can be returned to the previous state.

The above-mentioned various matters on the slide continuation icon 72 are also applicable to setting of the slide amount and the slide speed when the cancelation icon 104 is used. Therefore, an intermittent slide can be performed when the cancelation icon 104 is used, for example. Different settings may be used so that an intermittent slide is performed by the slide continuation icon 72 while a continuous slide is performed by the cancelation icon 104.

Convenience of the slide continuation icon 72 is improved by providing the cancelation icon 104 and the slide continuation icon 72 as a set.

The cancelation icon 104 can be combined with another continuation icon. A design of the continuation icon 104 is in no way limited to that illustrated in FIG. 41.

<Effects>

According to the information display device 10, the above-mentioned various effects can be obtained, and, as a result, a high convenience can be provided. Although an example in which a gesture operation is a drag, and a screen image movement-or-modification type function associated with the drag is a slide function is described above, similar effects can be obtained with respect to the other gesture operations and the other screen image movement-or-modification type functions.

<Modifications>

An example in which display information displayed by the display unit 12 is a map image is described above. Use of a continuation icon, however, is in no way limited to use for the map image. The continuation icon can be used for a slide of a book, a list of titles such as song titles, and a list of Web search results, for example. The continuation icon can also be used for turning pages of an electronic book and the like, and selection of contents of an electronic album and the like, for example.

Display information targeted for control over a gesture operation and a continuation icon may be displayed on the entire display surface or may be displayed on a part of the display surface. The display information displayed on the part of the display surface is display information within a window provided to the part of the display surface, for example. The part of the display surface may be one-dimensional, as illustrated in FIG. 42. That is to say, in the example of FIG. 42, elements A, B, C, D, E, F, G, H, and I that form display information move in a line (i.e., in a state in which these elements are connected to each other) on a zigzag path, and the movement is controlled by a drag or a flick.

A contact type touch panel is described above as an example of the input unit 14. A non-contact type (also referred to as three-dimensional (3D) type) touch panel, however, may be used as the input unit 14.

According to the non-contact type, an area in which a sensor group can perform detection (i.e., the input area in which user input can be received) is provided as a three-dimensional space on the input surface, and a position obtained by projecting a finger in the three-dimensional space onto the input surface is detected. Some non-contact types have a system that can detect a distance between the input surface and the finger. According to such system, the position of the finger can be detected as a three-dimensional position, and approach and retreat of the finger can further be detected. Various systems of the non-contact type touch panels have been developed, and a projected capacitive system as one example of a capacitive system is known.

Although a finger is described above as an example of the indicator used by a user for input, a body part other than the finger can be used as the indicator. Furthermore, a tool such as a touch pen (also referred to as a stylus pen) may be used as the indicator.

So-called motion sensing technology may be used for the input unit 14. Various types of motion sensing technology have been developed. One known type is technology of detecting a motion of a user by the user grasping or wearing a controller on which an acceleration sensor and the like is mounted, for example. Another known type is technology of extracting a feature point of a finger and the like from an image captured by a camera, and detecting a motion of a user from a result of the extraction, for example. An intuitive operating environment is provided by the input unit 14 using the motion sensing technology.

Although the input and display unit 20 is described above as an example, the display unit 12 and the input unit 14 may be arranged separately from each other. In this case, an intuitive operating environment is provided by configuring the input unit 14 by a touch panel and the like.

The information display device 10 may further include an element other than the above-mentioned elements 12, 14, 16, and 18. For example, one or more of a sound output unit that outputs auditory information, a communication unit that performs wired or wireless communication with a variety of devices, and a current position detector that detects a current position of the information display device 10 in accordance with global positioning system (GPS) technology, for example, may be added.

The sound output unit can output an operating sound, sound effects, a guidance sound, and the like. For example, a notification sound can be output at a timing of appearance, use, and deletion of the continuation icon. The communication unit can be used to newly acquire and update information to be stored in the storage 18, for example. The current position detector can be used to execute a navigation function, for example.

An application of the information display device 10 is not particularly limited. For example, the information display device 10 may be a portable or desktop information device. Alternatively, the information display device 10 may be applied to a navigation device or an audio visual device installed in a mobile object such as an automobile.

It should be noted that the present invention can be implemented by making modifications or omissions to the embodiment as appropriate without departing from the scope of the present invention.

### REFERENCE SIGNS LIST

10 Information display device, 12 Display unit, 14 Input unit, 16 Controller, 18 Storage, 20 Input and display unit, 32 Display surface, 32b Peripheral area, 34 Input surface (input area), 34b Peripheral area, 70 Drag, 70a Start point, 70b End point, 70c End point area, 70d Extended line, 70e Start point-side portion, 70f End point-side portion, 72 Slide continuation icon, 80 Zoom-in continuation icon (display size change continuation icon), 82 Zoom-out continuation icon (display size change continuation icon), 84 Clockwise-rotation continuation icon, 86 Counterclockwise-rotation continuation icon, 90 Slide direction, 100 Zoom-in icon (display size change icon), 102 Zoom-out icon (display size change icon), 104 Cancelation icon, S10, S30, S50 Processing flow

1-36. (canceled)

37. An information display device comprising:
a display having a display surface;
a receiver receiving a user operation;
a processor configured to execute a program; and
a memory that stores the program which, when executed by the processor, results in performance of steps comprising,
causing, when said user operation is a gesture operation associated with a screen image movement-or-modification type function of controlling display information on said display surface in a control direction set in accordance with a gesture direction, a continuation icon for executing said screen image movement-or-modification type function to be displayed on said display surface, and
executing, when said user operation is an execution instruction operation with respect to said continuation icon, said screen image movement-or-modification type function in said control direction that is the same as that of said gesture operation involved in appearance of said continuation icon.

38. The information display device according to claim 37, wherein
said memory stores the program which, when executed by the processor, results in performance of steps comprising,
causing said continuation icon to be displayed when said gesture operation is continuously repeated in the same gesture direction a predetermined number of times.

39. The information display device according to claim 37, wherein
said memory stores the program which, when executed by the processor, results in performance of steps comprising,
causing said continuation icon to be displayed when duration of a single of said gesture operation reaches a predetermined threshold.

40. The information display device according to claim 38, wherein
said memory stores the program which, when executed by the processor, results in performance of steps comprising,
causing said continuation icon to be displayed when a speed of the repetition of said gesture operation is equal to or higher than a predetermined threshold.

41. The information display device according to claim 37, wherein
said memory stores the program which, when executed by the processor, results in performance of steps comprising,
causing said continuation icon to be displayed when a speed of a single of said gesture operation is equal to or higher than a predetermined threshold.

42. The information display device according to claim 37, wherein
said memory stores the program which, when executed by the processor, results in performance of steps comprising,
causing said continuation icon to be displayed when a gesture amount of a single of said gesture operation reaches a predetermined threshold.

43. The information display device according to claim 37, wherein
said memory stores the program which, when executed by the processor, results in performance of steps comprising,
causing said continuation icon to be displayed when an end point of said gesture operation corresponds to a point in a predetermined area on said display surface.

44. The information display device according to claim 37, wherein
said memory stores the program which, when executed by the processor, results in performance of steps comprising,
causing said continuation icon to be displayed when said gesture operation is followed by a continuation icon call operation, or when a non-operating state continues for a predetermined time period after said gesture operation.

45. The information display device according to claim 37, wherein
said memory stores the program which, when executed by the processor, results in performance of steps comprising,
reflecting a gesture amount or a gesture speed of said gesture operation in a control amount or a control speed for said display information when said execution instruction operation is performed with respect to said continuation icon.

46. The information display device according to claim 37, wherein
said memory stores the program which, when executed by the processor, results in performance of steps comprising,
causing a cancelation icon for canceling said execution instruction operation performed with respect to said continuation icon to be displayed on said display surface together with said continuation icon, and
returning, when said user operation is a cancelation execution operation with respect to said cancelation icon, said display information on said display surface to a state before said screen image movement-or-modification type function is executed by said continuation icon.

47. The information display device according to claim 37, wherein
said memory stores the program which, when executed by the processor, results in performance of steps comprising,
associating an end point of said gesture operation or an end point area defined so as to include said end point with said display surface, and
causing said continuation icon to be displayed in said end point area on said display surface.

48. The information display device according to claim 37, wherein
said memory stores the program which, when executed by the processor, results in performance of steps comprising,
associating a gesture track of said gesture operation or an extended line from said gesture track with said display surface, and
causing said continuation icon to be displayed on said extended line on said display surface.

49. The information display device according to claim 37, wherein
said continuation icon is a strip-shaped icon.

50. The information display device according to claim 37, wherein
said continuation icon is displayed by a different display attribute from the other icons.

51. The information display device according to claim 37, wherein
said memory stores the program which, when executed by the processor, results in performance of steps comprising,
causing said continuation icon to be deleted from said display surface, when a state in which said execution instruction operation performed with respect to said continuation icon is not input continues, or when said user operation is a continuation icon deletion operation.

52. The information display device according to claim 37, wherein
said screen image movement-or-modification type function is a slide function of sliding said display information in said control direction,
said control direction is a slide direction of said display information,
said continuation icon is a slide continuation icon for continuing said slide function, and
said memory stores the program which, when executed by the processor, results in performance of steps comprising,
associating a gesture track of said gesture operation or an extended line from said gesture track with said display surface, and
setting a direction of said extended line to said slide direction on said display surface.

53. The information display device according to claim 37, wherein
said screen image movement-or-modification type function is a slide function of sliding said display information in said control direction,
said control direction is a slide direction of said display information,
said continuation icon is a slide continuation icon for continuing said slide function, and
said memory stores the program which, when executed by the processor, results in performance of steps comprising,
associating a gesture track of said gesture operation or an extended line from said gesture track with said display surface, and
extracting, as said slide direction, a direction that is the closest to a direction of said extended line from a plurality of directions set so as to have an origin at an end point of said gesture track on said display surface.

54. The information display device according to claim 37, wherein
said screen image movement-or-modification type function is a slide function of sliding said display information in said control direction,
said continuation icon is a slide continuation icon for continuing said slide function, and
said memory stores the program which, when executed by the processor, results in performance of steps comprising,
performing, when said user operation is a combination operation of said execution instruction operation with respect to said slide continuation icon and a display size change operation for changing a display size of said display information, a slide and a display size change with respect to said display information simultaneously.

55. The information display device according to claim 54, wherein
said memory stores the program which, when executed by the processor, results in performance of steps comprising,
judging, when said slide continuation icon is touched together with a point other than said slide continuation icon, that said user operation is said combination operation.

56. A display information operation method comprising:
receiving a user operation;
identifying said user operation;
displaying, when said user operation is a gesture operation associated with a screen image movement-or-modification type function of controlling display information on a display surface in a control direction set in accordance with a gesture direction, a continuation icon for executing said screen image movement-or-modification type function on said display surface; and
executing, when said user operation is an execution instruction operation with respect to said continuation icon, said screen image movement-or-modification type function in said control direction that is the same as that of said gesture operation involved in appearance of said continuation icon.
